(19) United States
(12) Patent Application Publication
(10) Pub. No.: US 2005/0209913 A1
(43) Pub. Date: Sep. 22, 2005

(54) Computer based system and method for facilitating commerce between shippers and carriers

(76) Inventors: William J. Wied, Dacula, GA (US); Clifford C. Isaacson, Tucker, GA (US); John S. Thomson, Atlanta, GA (US); Brian Flint, Snellville, GA (US); Diane L. Dreher, Atlanta, GA (US); Daniel A. Murray, Atlanta, GA (US); Rick MacConnell, Suwanee, GA (US); John Paul Simpson, Roswell, GA (US)

Correspondence Address: BLANK ROME LLP, 600 NEW HAMPSHIRE AVENUE, N.W., WASHINGTON, DC, 20037, US

(21) Appl. No.: 11/128,212

(22) Filed: May 13, 2005

Related U.S. Application Data
(63) Continuation of application No. 09/721,421, filed on Nov. 22, 2000, now abandoned.
(60) Provisional application No. 60/194,727, filed on Apr. 5, 2000.
(60) Provisional application No. 60/245,801, filed on Nov. 3, 2000.
(60) Provisional application No. 60/252,183, filed on Nov. 20, 2000.

(51) Int. Cl. G06F 17/60

(52) U.S. Cl. 705/12; 705/1

(57) ABSTRACT

An internet based method of facilitating commerce between shippers and carriers includes the steps of capturing electronic shipment requests for available shipments, the shipment requests including shipment specific criteria and carrier access criteria, and storing the electronic shipment requests in a database. The electronic shipment requests are presented for action to the remote carriers meeting the carrier access criteria. These remote carriers may reply to the shipment requests with fulfillment offers, which are responsive to the presented shipment requests. Carrier fulfillment offers are received and presented to the remote shippers originating the electronic shipment requests. An Internet based system for implementing the method of the present invention is also disclosed.

### CROSS REFERENCE TO RELATED APPLICATIONS

This application claims the benefit of U.S. Provisional Application No. 60/194,727, filed Apr. 5, 2000, U.S. Provisional Application 60/245,801, filed Nov. 3, 2000, and U.S. Provisional Application 60/______, entitled: “Improved Computer System and Method for Facilitating Commerce Between Shippers and Carriers Incorporating Improved DataDepot Functionality,” filed Nov. 20, 2000, all of which are hereby incorporated by reference herein.

### BACKGROUND OF THE INVENTION

1. Field of Invention

The present invention relates generally to the field of electronic commerce, and more particularly, to the field of logistical support provided to the transportation industry through the use of computers, computer systems, and computer networks.

While the present invention is subject to use in connection with a wide range of carrier industries, it is particularly well suited for use in connection with the trucking industry.

2. Technical Background

According to Standard & Poor's DRI (“DRI”), in 1999 the United States domestic freight transportation business generated over $450 billion in annual revenues, with $370 billion of that amount being handled by the trucking industry. In addition, according to a report issued in 1997 by the U.S. Department of Transportation, Office of Motor Vehicles, the trucking industry is a highly fragmented industry, with over 99% of the 450,000 motor carriers having annual freight revenues of $3 million or less.

The trucking industry can be segmented by business orientation into private carriage, for-hire truckload, and less-than-truckload (“LTL”) which generated 52%, 45% and 3%, respectively, of the total shipments for the trucking industry in 1997, according to a 1999 report issued by DRI. As a result, the market segments for truckload and LTL comprise approximately $88 billion of the total revenues for the trucking industry. DRI estimates the portion of freight moved by private carriers will decrease from 52% in 1997 to 47% in 2006, while the portion of freight moved by public or for-hire carriers will continue to increase. Moreover, 1999 figures from the American Trucking Association, indicate that capacity for both of these segments was underutilized, with truckload carriers averaging 13% to 19% empty miles, and LTL carriers averaging 6% to 13% empty miles, where empty miles is defined as mileage traveled without a payload. Truckers typically accumulate empty miles while traveling to a shipment's point of debarkation, or while returning after a shipment has been delivered to its final destination.

Both segments are also rapidly adopting technology, and over half of the companies in these segments are Internet users, with a compound growth rate of 20% from 1996 through 1998, according to an ATA report issued in July 1999. Goldman Sachs & Company estimated, in a report issued in 1999, a compound growth rate of 66% per year in Internet-based transportation revenues over the subsequent five years. As the trucking segment accounts for approximately 80% of the total transportation industry revenues, a computer based system and method for facilitating commerce in the transportation industry is ripe for implementation.

According to logistics industry consultant Herbert W. Davis, on average, total logistics costs for shippers in 1997 amounted to nearly 9% of sales, with smaller shippers paying an average of 50% more than very large shippers in total logistics costs. To manage transportation costs and maximize margins, shippers continuously seek out and implement process improvements that result in increased process efficiencies and lower shipping costs. Many of the traditional shipper logistics management practices are characterized by complex manual processes that offer numerous opportunities to increase process efficiencies and lower overall costs.

The traditional transaction process begins with a shipper's shipping manager being prompted by a shipper's Traffic Management System (“TMS”) or software based order management system that an item or items require shipping. The information regarding a shipment is then either automatically forwarded to a pre-selected group of carriers using Electronic Data Interchange (“EDI”), or the shipping manager notifies carriers to bid for the shipment using the telephone or some other communication method. Thereafter, the first round of carriers notified will inform the shipper whether they can accept all or a portion of the load offered. To the extent a shipper determines that it needs to locate additional carrier capacity, the shipper continues to put the shipment out to bid using one of the methods described above until it has obtained sufficient carrier capacity for the shipment.

Generally speaking, shippers and carriers that employ EDI technology incur substantial costs in connection with its use. In addition to the fixed costs incurred in connection with acquiring the necessary hardware and software to implement an EDI system, there are ongoing costs associated with an EDI system's use. Shippers and carriers must subscribe to a value-added network (a “VAN”) in order to transmit data to the opposite party. VANs typically charge a combination of a flat fee and a use charge for transmission of data. Moreover, EDI systems are not typically architecturally flexible relative to newer technologies, and reconfiguring an EDI system is resource intensive and time consuming.

In today's market, the actual rate charged for the shipment is determined in a number of ways. Often a shipper and carrier will negotiate and agree on the price to be charged for handling a given shipment. In many cases, rates are negotiated based on a discount from published tariffs, which are updated infrequently and do not necessarily reflect current market conditions such as fuel prices, capacity or demand. This rate is usually documented in a trip contract that is prepared by either a shipper or carrier. In cases where a shipper and carrier have a pre-existing contract in place, the terms of the pre-existing contract may govern the shipping transaction. However, many traditional contracts between shippers and carriers have extremely complex rate schedules, which often create uncertainty regarding the proper rate to apply, and which often result in billing errors.

In the event a shipper is unable to locate sufficient capacity using its own resources, it will often contact a broker to obtain the needed capacity. Traditional freight brokers will locate capacity for the shipper, but they stand between the shipper and the carrier to do so. Generally speaking, shippers employing freight brokers have little input regarding the carrier who will handle their shipments.

Moreover, brokers typically charge large commissions ranging from 11% to 13% of a gross freight bill. Brokers are typically paid by either billing the shipper for their fee, or by billing the shipper for a pre-arranged transportation charge and keeping the difference between the amount of the transportation charge billed to the shipper and the carrier's charge to the broker for transporting the freight.

Once a shipment has been assigned to a carrier or carriers, the shipper will prepare the appropriate bills of lading and wait for the carrier or carriers to arrive and pick up the shipment. Occasionally, a carrier that has committed to a shipment will be unable to handle the shipment itself. In such cases, carriers often turn to brokers to locate a carrier to cover a shipment or broker the shipment themselves. The transaction structure for these transactions is substantially similar to the structure described above with respect to a broker acting on behalf of an ordinary shipper.

Provided that a carrier is found for the load, the carrier or carriers then arrive and pick up the shipment and deliver it to the assigned destination(s). A shipper's ability to track the progress of its shipment during delivery is dependent upon the shipment tracking capability of a given carrier. Shipment tracking capability varies from real time tracking of precise shipment location using satellite technology, to less precise manual systems that require drivers to periodically “phone in” their position. Having the receiving party sign the bill of lading pertaining to a given shipment typically proves freight delivery.

The signed bill of lading is then forwarded to the carrier's billing department so that a freight bill can be generated. Usually, freight bills are prepared manually, one at a time, due to the complex contractual terms that are often applicable to such bills. In addition to determining the proper rate to apply to a shipment, if applicable, other surcharges (such as charges for wait times, extra stops, etc.) are added to the bill. The personnel preparing the freight bills are also often subject to production quotas. Thus, the time pressure associated with bill preparation increases the likelihood that errors will be introduced into the billing process (including fundamental errors such as sending a freight bill to the wrong party). Once the freight bill is prepared it is forwarded to the “bill to” party indicated on the appropriate bill of lading. Sometimes, freight bills are forwarded using an EDI; otherwise they are forwarded through traditional channels of commerce.

Once the “bill to” party receives the freight bill, it must be reviewed by the “bill to” party's personnel to determine the accuracy of the bill. Bills are also checked to confirm that the “bill to” party is the proper recipient of the bill and that contract terms such as rates and surcharges have been properly applied. Once the “bill to” party's personnel have completed their review of the bill, the bill is approved for payment and payment is made. The “bill to” personnel reviewing the freight bills, are also often subject to production quotas. Again, the time pressure created by these quotas increases the likelihood that the “bill to” party wrongly pays charges appearing on the freight bill.

As a result of the complexities inherent in the bill processing procedures described above, shippers frequently engage freight bill auditors to review their freight bills and correct billing errors that are discovered in the review process. Freight bill auditors are employed primarily to (i) confirm that the freight bill was sent to the proper party, (ii) confirm that the proper contractual rate was applied to the shipment, and (iii) ensure that penalties for carrier non-performance are accurately reflected on the freight bill. Freight bill auditors typically charge a 30% commission on money recovered on behalf of the “bill to” party. According to the American Trucking Association, in 1998, revenues for the freight bill audit industry amounted to approximately $6 billion.

Due to the significant resources that must be devoted in order to locate carrier capacity and manage the freight bill paying process, a number of shippers are turning to third party logistics providers to assist them in managing these and other aspects of their logistical needs. Third party logistics providers offer a range of services from providing assistance in locating carrier capacity to managing a complete outsource solution to a shipper's logistical needs. Third party logistics providers are compensated in a variety of ways depending on the arrangement between the shipper and the third party logistics provider. Frequently occurring compensation arrangements include a fixed brokerage commission per shipment, a monthly administration charge, a pre-arranged rate matrix for shipper's freight charges, or some combination thereof.

More recently, shippers have employed carriers as “Rolling Warehouses” to improve logistical efficiencies. Shippers using the “Just-in-Time” inventory management system commonly employ this practice. Where shippers employ the “Rolling Warehouse” model, the importance of satisfactory carrier performance increases due to the fact that such shippers only maintain enough inventory to satisfy immediate operational requirements. The need for timely and accurate information regarding a carrier's performance is critical for such shippers if effective operations are to be maintained.

To date, many business-to-business e-commerce companies have focused on developing reliable systems to support marketing and sales and have not focused on the fulfillment process, including warehousing and transportation. As a result, many e-commerce companies face a situation where the marketing and sales of their products have outpaced their logistical infrastructure. Accordingly, many customers of e-commerce companies are forced to arrange for shipment of the goods purchased using their own resources.

Under any of the traditional approaches to logistics described above, pricing is largely based on rate schedules appearing in contracts between shippers and carriers or is negotiated based on a discount from published tariff rates. Even in cases where a shipper and carrier agree on pricing independent of these factors, pricing is usually determined after a shipper makes inquiry of a limited number of carriers. As a result, even in cases where pricing is negotiated on a shipment-by-shipment basis, the price may not be indicative of broader market conditions. Consequently, shippers may not receive the pricing benefit of excess capacity that may be available beyond their immediate circle of contacts. Similarly, carriers seeking shipper demand to improve their rate of utilization and profitability are not afforded the opportunity to compete with the rates offered by the carriers who were contacted in connection with a shipment.

An additional shortcoming relates to the inefficiency of the search process. Under the traditional approach to logistics support, carrier capacity is located for each shipment through a serial process that may involve several rounds of contacts between the shipper and the relevant carriers before a shipment is awarded to a carrier. This often means that in order to find sufficient capacity for a day's shipments, a shipping manager must constantly maintain contact with several different carriers throughout the day. As a result, often a shipping manager is required to spend a large portion of his time simply finding capacity, rather than focusing on other areas of his or her responsibility.

Another shortcoming relates to the inefficiencies related to the processing of freight bills. A traditional approach to processing freight bills is paper-based and labor intensive for both shippers and carriers. The traditional approach also contains many opportunities for the introduction of erroneous information into the billing process. The primary cause of errors in the billing process is the extremely complicated rate schedules that apply to many shipping transactions. The labor-intensive nature of the billing process also gives rise to more fundamental errors in freight bills such as billing the wrong party. The complexities of the freight billing system have given rise to an entire industry that is simply devoted to reviewing freight bills in order to confirm that they properly reflect the terms agreed upon between a shipper and carrier.

Yet another shortcoming is due to the limited availability of information relating to the available shippers and carriers. The normative and comparative national industry data currently available to shippers and carriers is less current and accurate than the information that could be provided to shippers and carriers if state-of-the-art technology is employed to gather and distribute such data. While this information is available, it has not been efficiently collected, analyzed, sorted and/or presented in a manner that is readily available and useable to the transportation industry. Employing state-of-the-art technology to generate more accurate and current national industry data for use by shippers and carriers would drastically improve shipper and carrier operating results and performance beyond current levels. In addition, shippers and carriers that are not nationally recognized are generally limited to a circle of contacts or local or regional markets in seeking transactions with opposite counterparts. Small to medium size shippers generally do not have shipping management offices with enough sophistication to seek carrier capacity beyond a certain geographical range. Likewise, small to medium size carriers typically do not have the marketing organizations necessary to take advantage of marketing opportunities on a national scale.

The advent of global computer networks such as the Internet has recently created a demand and an instant market for services and systems such as those embodied by the present invention. The Internet is inclusive of a vast number of computers and computer networks that are interconnected through communication links. The interconnected computers exchange information using various services, such as electronic mail, Gopher, and the World Wide Web (“WWW”). The WWW service allows a server computer system (i.e., Web server or Web site) to send graphical Web pages of information to a remote computer system following a remote computer system request. The remote computer system is then able to display the Web pages.

Each resource (e.g., computer or Web page) of the WWW is uniquely identifiable by a Uniform Resource Locator (“URL”). To view a specific Web page, the remote computer system specifies the URL for the Web page in a request (e.g., a Hypertext Transfer Protocol (“HTTP”) request). The request is forwarded to the Web server that supports that Web Page, and when that Web server receives the request, it sends the Web page to that remote computer system. When the remote computer system receives that Web page, it typically displays the Web page using a browser. A browser is a special-purpose application program that effects the requesting of Web pages and the displaying of those Web pages.

Currently, Web pages are typically defined using Hypertext Mark-up Language (“HTML”). HTML provides a standard set of tags that define how a Web page is to be displayed. When a user indicates to the browser to display a Web page, the browser sends a request to the server computer system to transfer to the client computer system an HTML document that defines the Web page. When the requested HTML document is received by the requesting computer system, the Browser displays the Web page as defined by the HTML document. The HTML document contains various tags that control the displaying of text, graphics, controls, and other features. The HTML document may contain URLs of other Web pages available on that server computer system or other server computer systems. Additionally, many Web sites contain Web pages that display customer information forms and other forms containing fields that can be completed by the client and sent directly to the Web site provider through the WWW using the Web site provider's own web site.

The World Wide Web is particularly well suited for conducting electronic commerce. Most recently, the focus of such electronic commerce has been on the sale and purchase of goods and services. The electronic commerce corporations, specializing in the transportation industry have recently entered this domain. However, unlike the present invention, such electronic commerce corporations have not provided a real-time dynamic marketplace for shippers and carriers as provided by the present invention.

One such electronic commerce corporation specializing in the trucking market provides an on-line broker approach, which requires the payment of up-front membership fees or brokerage fees by participating shippers and/or carriers. Much like a conventional broker, the Internet broker receives shipment requests from member shippers and provides third party negotiation of carrier rates among a pool of participating carriers. In theory, the Internet broker negotiates the lowest transportation rate that will result in movement of the shipment from its point of origin to its point of destination. Unlike the present invention, however, data warehousing of carrier and shipper information is not a provided service, and carrier participation is generally limited to bidding on shipments provided to it by the third party broker. Moreover, the broker in advance of the load being posted often determines pricing. In such a system, direct, real-time interaction between shippers and carriers is non-existent.

Other electronic commerce corporations provide traditional load-posting sites where for owner-operator and small trucking companies to post their carrying capacity for viewing by shippers visiting the corporation's Web site. The site is similar to standard bulletin boards and provides no carrier/shipper interaction or negotiating. Fees are generally high and substantially all communications between the shippers and carriers pass through an intermediary such as a broker. Information passes one-way in such systems and value-added features such as those provided by the present invention are not available.

What is needed therefore, but seemingly unavailable in the art, is a system and method for streamlining electronic commerce in a network environment, and particularly, the Internet, which obviates the shortcoming and limitations of other systems and methods known in the art. More specifically, there is a need for an Internet based system and method that facilitates the efficient and economic use of carrier capacities while maximizing shipper's delivery criteria. Such a system and method will substantially reduce empty miles for carriers, reduce logistical support man-hour requirements for both shippers and carriers, and increase the number of on time deliveries. The system will also preferably reduces the costs associated with shipments, and provide shippers and carriers with access to an extensive database of information pertaining to shippers and carriers that will preferably streamline logistical operation for future shipments. It is to the provision of such a system and method that the present invention is primarily directed.

### SUMMARY OF THE INVENTION

One aspect of the present invention relates to a method of facilitating commerce between shippers and carriers. The method includes the steps of capturing electronic shipment requests for carrier capacity, the electronic shipment requests originating from remote shippers and including shipment specific criteria and carrier access criteria, and storing the electronic shipment requests in a database of a Dynamic Marketplace System (DMS). The method further includes the steps of presenting the electronic shipment requests to remote carriers meeting the carrier access criteria, receiving carrier fulfillment offers responsive to the presented electronic shipment requests, and presenting the responsive carrier fulfillment offers to the remote shippers originating the electronic shipment requests.

In another aspect, the invention relates to an automated method of facilitating commerce between shippers and carriers. The method includes the steps of capturing electronic shipment requests for available shipments, the electronic shipment requests originating from remote shippers and including shipment specific criteria and carrier access criteria, and storing the electronic shipment requests in a database of a DMS. The method further includes capturing electronic carrier availability data from remote carriers, including carrier specific criteria and shipper access criteria and storing the electronic carrier availability data in the first database of the DMS. The access criteria of the shippers and the carriers are electronically compared to determine shipper and carrier compatibility, and the shippers and carriers meeting the carrier and shipper access criteria, respectively, are electronically notified. Electronic shipment requests are presented to remote carriers meeting the carrier access criteria, and carrier availability data is presented to remote shippers meeting the shipper access criteria.

In yet another aspect, the invention relates to a system constructed and arranged to facilitate commerce between shippers and carriers. The system includes an interface communicating with remote shippers and carriers in a network environment to accept electronic shipment requests for available shipments and to accept carrier fulfillment offers. The electronic shipment requests include both shipment specific criteria and carrier access criteria. A Dynamic Marketplace System (DMS), including a database, communicates with the interface to receive the electronic shipment requests and carrier fulfillment offers, and communicates with the database to facilitate storage of the shipment requests and fulfillment offers in the database. The dynamic market engine cooperates with the database to present electronic shipment requests to remote carriers meeting the carrier access criteria, receive carrier fulfillment offers responsive to the presented electronic shipment requests, the carrier fulfillment offers at least satisfy the specific shipment criteria, and to present the responsive carrier fulfillment offers to the remote shippers originating the electronic shipment request.

In a further aspect, the invention is directed to a system constructed and arranged to facilitate commerce between shippers and carriers. This system includes an interface communicating with remote systems in a network environment to accept electronic shipment requests for available shipments and to accept carrier fulfillment offers. The electronic shipment requests identify shipment specific criteria and carrier access criteria. This system also includes a dynamic market system having a dynamic market engine, a data base, and an open market services interface constructed and arranged to interpret the electronic shipments requests and store the interpreted electronic shipment requests in the data base. The dynamic market engine cooperates with the open market services interface and the data base to present the electronic shipment requests to remote carriers meeting the carrier access criteria, receive carrier fulfillment offers responsive to the presented electronic shipment requests, and present the responsive carrier fulfillment offers to the remote shippers originating the electronic shipment requests.

In a still further aspect, the present invention relates to a system constructed and arranged to facilitate commerce between shippers and carriers. The system includes a rule-based data base including shipper business terms and carrier business terms. An interface communicates with remote shippers and carriers in a network environment to accept electronic shipment requests for available shipments and carrier availability. A dynamic market exchange engine cooperates with the rule-based data base and the interface to match shipment requests with carrier availability.

In addition, the system and method of the present invention provides a data warehouse capability that can be used by both the shipper and carrier companies to view and analyze their past transaction history as well as aggregated pricing and freight information from other companies. This information is extremely valuable in the logistical analysis of a business' operating practices. Shipping companies can use this information to determine how they will organize their distribution model. Carrier companies can use this information to determine how to deploy their fleets to maximize payload and profitability.

Generally speaking, the system and method of the present invention provides a robust Internet based market environment where shippers can post shipment requests, and carriers can provide fulfillment offers responsive to the posted shipment requests. Unlike other transportation marketplaces currently known in the art, shippers and carriers have complete control over their transactions. Shippers may set how shipments are posted, define delivery requirements, specify which of the participating carriers will have access to the posted shipment request, set reserve amounts, determine how long shipments are listed in the market, and define other shipper specific criteria or requirements to be fulfilled by any one or more carriers from the available pool of participating carriers. Likewise, carriers may filter which shipments requests are presented to them, set service regions and lanes of traffic, post multiple fulfillment offers with date exceptions, and set other carrier specific criteria that will advise shippers as to how and when carriers can deliver the loads associated with the shipment request.

In addition, the system and method of the present invention provides a complete electronic portal to the transportation industry, allowing shippers and carriers to receive personalized industry information, correspond with industry experts, chat on-line with other shippers and carriers, provide communication links and information pertaining to vendors and customers, provide for paperless invoicing and transaction processing, provide real-time scheduling of individual shipments from originating to destination dock doors, and provide notification to shippers and/or carriers via pager, cell phone, personal digital assistance (“PDAs”) and other personal communication devices.

The system and method of moderating electronic communication in the present invention results in a number of advantages over other systems and methods known in the art. For example, true market pricing is enabled since transactions are completed in a much broader marketplace than traditionally available to either shippers or carriers.

Another advantage of the method and system of the present invention is that the search for carrier capacity is more efficient since shippers (once properly interfaced) are able to automatically upload information from their Transportation Management System (“TMS”) to the DMS, and simultaneously communicate the uploaded information to the desired carriers in accordance with selected shipper access criteria. Searching is made more efficient as shippers can look to a single point of contact instead of several when trying to obtain needed carrier capacity from multiple carriers. Additionally, searching may be assisted by the availability of qualitative partner rating information regarding carrier performance.

Yet another advantage is that the carriers' too can look to a single point of contact with regard to the status of outstanding fulfillment offers provided to multiple shippers. Moreover, searching may be made more efficient as a result of the availability of qualitative partner rating information regarding shipper performance. Such detailed historical information archived by the system can be provided to carriers and shippers alike. This information provides data pertaining to the timeliness of deliveries and payment for deliveries, accuracy of reported shipment weights, billing accuracy, percentage of goods damaged during delivery, number of claims made by shippers for damaged goods, carrier maintenance schedules, and other measurable criteria to the system participants so that both shippers and carriers can make informed decisions as to what shipments carriers will provide fulfillment offers for, and which carriers shippers should consider to transport their loads. Price does not have to be the sole factor in selecting business partners. Rather, the system facilitates selection based on price and quality mix. In addition, problems associated with limited visibility in the market are largely overcome due to the systems ability to overcome limitations imposed by geography.

An additional advantage is that the uncertainty associated with the traditional freight billing process is largely eliminated. The system of the present invention automatically captures important information regarding the shipping transaction such as rate and “bill to” party information. This information provides shippers and carriers with a readily available source to verify information regarding the operative terms of shipping transactions. The availability of this information will greatly simplify any post-transaction audit process.

A further advantage is that the on-line payment processing system further simplifies the freight bill payment process by adding features such as automated proof of delivery and electronic funds transfer. The on-line payment processing system of the present invention greatly reduces the effort expended on the billing process by providing a paperless, documented environment that substantially eliminates the need for post-transaction audits. Carriers will also realize further significant advantages in terms of reduced payment times.

Additional features and advantages of the invention will be set forth in the detailed description which follows, and in part will be readily apparent to those skilled in the art from the description or recognized by practicing the invention as described herein.

It is to be understood that the foregoing general description and the following detailed description are merely exemplary of the invention, and are intended to provide an overview or framework for understanding the nature and character of the invention as it is claimed. The accompanying drawings are included to provide further understanding of the invention, illustrate various embodiments of the invention, and together with the description, serve to explain the principles and operation of the invention.

### BRIEF DESCRIPTION OF THE DRAWINGS

FIG. 1 is a process flowchart for registering a shipper or carrier as a registered user of the present invention.

FIG. 2 is a user interface web page representative of a home page for manual entry of data of the present invention.

FIG. 3 is a representative login page for the web site of the present invention.

FIG. 4 is a user interface web page representative of a MarketPlace Home Page of the present invention.

FIG. 5 is a representative user screen titled “My Profile Setup Page” on which a web site user of the present invention enters user specific profile information.

FIG. 6 is a representative user screen titled “Company Information Setup Page” on which a web site user of the present invention enters company specific information.

FIG. 7 is a representative user screen “Company Locations Setup Listing Page” on which a web site user of the present invention can enter location specific information.

FIG. 8 is a representative user screen that represents the “new” functionality of the “Company Location Setup Detail Page” on which a web site user of the present invention can create a new location for a company.

FIG. 9 is a representative user screen “User Setup Listing Page” on which a web site user of the present invention can enter specific user information.

FIG. 10 is a representative user screen, which represents the “new” functionality of the “User Setup Detail Page” on which a web site user of the present invention can create a new user for a company.

FIG. 11 is a representative user screen “User Group Setup Listing Page” on which a web site user of the present invention can enter specific user group information.

FIG. 12 is a representative user screen, which represents the edit functionality of the “User Group Setup Detail Page” on which a web site user of the present invention can edit an existing user group of a company.

FIG. 13 is a representative user screen, which represents the “new” functionality of the “User Group Setup Detail Page” on which a web site user of the present invention can create a new user group for a specified company.

FIG. 14 is a representative “Contract Information Listing Page” user screen on which a carrier user of the web site of the present invention can create, edit and delete contracts of the user.

FIG. 15 is a representative “Partner List Listing Page” user screen on which a user of the web site of the present invention can create, edit and delete partner lists.

FIG. 16 is a representative user screen, which represents the “new” functionality of the “Partner List Setup Detail Page” on which a web site user of the present invention can create a new partner list for a specified location of a company.

FIG. 17 is a representative user screen, which represents the “edit” functionality of the “Partner List Setup Detail Page” on which a web site user of the present invention can edit an existing partner list for a specified location of a company.

FIG. 18 is a representative user screen “Partner Information Detail Pate” on which a user of the web site of the present invention can create, edit and delete partner lists.

FIG. 19 is a representative “Region Information Listing Page” user screen on which a user of the web site of the present invention can create, edit and delete regions specific to a company.

FIG. 20 is a representative user screen, which represents the “new” functionality of the “Region Information Detail Page” on which a web site user of the present invention can create a new region for a specified location of a company.

FIG. 21 is a representative user screen, which represents the “edit” functionality of the “Region Information Setup Detail Page” on which a web site user of the present invention can edit an existing region of a company.

FIG. 22 is a representative “Peer Review Page” user screen on which a user of the web site of the present invention can give, receive, analyze and customize the peer review module of the present invention.

FIG. 23 is a representative user screen, which represents the “Give A Peer Review Page” functionality of the “Peer Review” module on which a web site user of the present invention can submit to a system of the present invention a review of a customer company.

FIG. 24 is a representative user screen, which represents the “Analyze All Reviews Page” functionality of the “Peer Review” module on which a web site user of the present invention can retrieve from a system of the present invention an analysis of peer review result.

FIG. 25 is a representative user screen which represents the “Get Your Peer Review Page” functionality of the “Peer Review” module on which a web site user of the present invention can retrieve from a system of the present invention a review from a customer company.

FIG. 26 is a representative user screen which represents the “Customize Peer Review Page” functionality of the “Peer Review” module on which a web site user of the present invention can customize the way in which the customer views data either when receiving a Company's own peer review information or a partner's peer review information.

FIG. 27 is a representative “Shipper Post Shipment Page” user screen, on which a shipper user of the web site of the present invention can post shipments electronically.

FIG. 28 is a representative user screen, which is part of the “Shipper Post Shipment Confirmation Page” module, which provides a shipper confirmation that a shipment is posted to the system including a DSM number.

FIG. 29 is a representative “Shipper View Shipment Detail Page” user screen on which a user of the web site of the present invention can view shipments that are on the system.

FIG. 30 is a representative “Search Shipments Page” user screen on which a user of the web site of the present invention can search for shipments that are posted on the system.

FIG. 31 is a representative “Shipper Search Shipments Results Page” user screen on which a user of the web site of the present invention can view the search results obtained from searching for shipments based on various criteria.

FIG. 32 is a representative user screen displayed as a functionality of the “Shipper View Shipment Page” module on which a user of the web site of the present invention can view open shipments on the system.

FIG. 33 is a representative “Bidder Listing Page” user screen displayed when a shipper on the web site of the present invention selects to view the bid(s) on a particular shipment that is posted on the system.

FIG. 34 is a representative “Terms of Selected Bid Page” user screen displayed when a shipper on the web site of the present invention selects to view the contract associated with particular shipment that is posted on the system.

FIG. 35 is a representative “Shipper Bid Acceptance Confirmation Page” user screen displayed when a shipper on the web site of the present invention selects to accept a particular bid place on a posted shipment.

FIG. 36 is a representative “Carrier Contract Information Listing Page” user screen, which lists for a carrier the contracts that belong to the carrier.

FIG. 37 is a representative “Carrier Contract Information Detail Page” user screen displayed when a shipper on the web site of the present invention selects to view the default contract on the system of the present invention.

FIG. 38 is a representative “Carrier's Trip Contract Setup Detail Page” user screen that represents the “new” functionality of the “Trip Contract Setup” on which a carrier who is a web site user of the present invention can create a new contract of a company.

FIG. 39 is a representative “Carrier Market View Shipments Page” user screen on which a carrier of the web site of the present invention can view the results obtained from the carrier selecting “View Shipments” from the hyperlink list.

FIG. 40 is a representative “Carrier Search Shipments Results Page” user screen on which a user of the web site of the present invention can search the system on various search criteria.

FIG. 41 is a representative “Carrier Market Bidding Page” user screen on which a carrier of the web site of the present invention can make a bid on a shipment currently on the system.

FIG. 42 is a representative “Bids for Market Page” on which a carrier of the web site of the present invention can choose to view all the bids against which the carrier is bidding on a specified shipment.

FIG. 43 is a representative “Carrier Market Bidding Confirmation Page” on which a carrier of the web site of the present invention can choose to view all the bids against which the carrier is bidding on a specified shipment.

FIG. 44 is a representative “Carrier Search Shipments Results Listing Page” user screen on which a user of the web site of the present invention can search the system on various search criteria.

FIG. 45 is a representative “Market Bidding Listing Page” user screen on which a carrier of the web site of the present invention can make a bid on a shipment currently on the system.

FIG. 46 is a representative “View Terms to Impose Charges” user screen represents a contract created by a carrier-user other that the default contract provided by the system.

FIG. 47 is a representative “Shipper Market View Additional Charges” user screen represents a contract created by a carrier-user other that the default contract provided by the system.

FIG. 48 is a representative “Shipper Select Bid” user screen on which a shipper of the web site of the present invention can choose to go with one of the users listed in the list.

FIG. 49 is a simplified illustration of the entire Market System including the Dynamic Market Engine (DMS), a network, a carrier interface and a shipper interface.

FIG. 50 is a simplified illustration of the DMS including the DME, the database, the network, and the interface portal.

FIG. 51 is a simplified illustration of the entire Market System including the Dynamic Market System (DMS), a network, a carrier interface and a shipper interface which is a manual data entry implementation.

FIG. 52 is a simplified illustration of the entire Market System including the Dynamic Market Engine (DMS), a network, a carrier interface and a shipper interface which is a manual data entry implementation.

FIG. 53 is a simplified illustration of the rule-base electronic matching architecture.

### DETAILED DESCRIPTION OF THE PREFERRED EMBODIMENTS

Generally speaking, the system and method of the present invention provides shippers and carriers a network enabled marketplace for coordinating the transportation of freight and streamlining logistical operations. The Dynamic Market System (“DMS”) of the present invention is a transportation marketplace that permits shippers and carriers to interact with each other in a real time environment. It matches shippers and carriers based on multi-variant criteria selected by one or more parties to the shipping transaction. It provides a marketplace rather than an auction environment. With respect to the present invention, price does not have to be the sole determining factor in awarding shipments to carriers. Instead, the DMS forwards all qualifying carrier fulfillment offers to the shipper so that the shipper can award the shipment to the carrier offering the best price/quality/service mix.

In accordance with the system and method of the present invention, shippers are able to post unassigned shipments to carriers with available capacity via the Internet, and can designate which carriers will be permitted to bid on an unassigned shipment based on transaction specific pre-selected criteria. Unlike other systems and methods known in the art, shippers can contact all desired carriers simultaneously, without the need for phone calls or other manual processes. All qualified carrier fulfillment offers can be automatically forwarded to the shipper at which time the shipper can, if desired, review all qualifying offers in a one step process.

Once a carrier is awarded a shipment, the carrier can be automatically notified of the award so that it can contact the shipper and arrange for pick up. In a preferred embodiment, a shipper's system can be interfaced with the DMS of the present invention, and all shipments generated by a shipper's TMS can be automatically uploaded into the DMS for posting. Information regarding a shipment including, among other things, rate and the proper billing party, is thus automatically captured by the system at the time a shipment is posted.

Carriers can also offer to service a shipment in the alternative, allowing carriers to structure multiple offers based on carrier designated criteria (i.e. the carrier offers a better rate if the shipper agrees to a pick up time more favorable to a carrier's schedule). In addition carriers can retract an offer prior to acceptance by a shipper if changing circumstances such as incoming shipments or rerouting needs make this desirable or necessary. Like shippers, carriers can also designate which shipments they will offer to service based upon pre selected criteria.

The system of the present invention also stores information entered by the shippers and the carriers, analyzes the date, and provides continuous access to that data. As a result, shippers and carriers can obtain summary reports regarding all of their transactions with the DMS. Shippers and carriers have the ability to access qualitative partner rating information (if available for a given shipper or carrier) prior to doing business with a given shipper or carrier. Carriers will be rated on factors such as on-time delivery, breakage rates etc. Shippers will be rated on factors such as timeliness and accuracy of shipper payments and wait times. Once properly interfaced, customers of e-commerce companies can arrange for shipping of goods purchased on the Internet as part of the normal transaction completion process.

In addition to these functionalities, the system of the present invention can also provide for on-line payment processing. Shipper and carrier systems can also be interfaced with the DMS of the present invention to facilitate functions such as shipment tracking and confirmation of delivery. Moreover, the system can be integrated with WAP and other wireless standards to provide two-way pager, cell phone, PDA, and other consumer communication devices. Accordingly, shippers and carriers will not be limited to access through traditional computer networks.

Large shippers usually have established contract relationships with multiple carriers and have already negotiated favorable rates with those carriers due to the volume of shipments they can offer. These shippers also usually have sophisticated TMS capabilities and employ EDI to exchange information with their contract carriers. Large shippers also tend to have established protocols for placing shipments with their contract carriers (i.e. certain carrier groups are awarded certain types of shipments). Occasionally, large shippers may experience periods of higher than normal demand for carrier capacity where the capacity of their established contract carrier base is exceeded.

Large shippers can use the system and method of the present invention to increase process efficiencies, capture transaction information and eliminate the need for EDI. As a result of the favorable rates enjoyed by large shippers, they can use the system of the present invention to post shipments on a pre-assigned basis to a carrier in accordance with their already established protocols. This approach allows the shipper to take advantage of the favorable rate offered by a carrier, while realizing the process efficiencies offered by the DMS's ability to simultaneously notify multiple carriers of a shipper's needs based upon shipper selected criteria. It also allows large shippers to consolidate transaction information regarding their dealings with multiple carriers into one readily available source, and further simplifies the freight bill paying process. Additionally, by using the DMS to exchange data via the Internet, the need for the more costly and less flexible EDI technology is largely eliminated. Finally, if a shipper finds that its need for carrier capacity exceeds its normally available resources, the DMS offers a readily available method for locating additional carrier capacity, at a cost that is significantly less than the fees charged by freight brokers or third party logistics providers.

Small and medium size shippers can take advantage of the DMS of the present invention in the same way as large shippers. In addition, because small to medium size shippers enjoy less leverage in negotiating favorable rates with carriers, the ability to post loads on the DMS gives small to medium shippers a previously unavailable method of seeking available carrier capacity on a national scale. Access to a broader base of excess carrier capacity will result in significant advantages to small to medium size shippers as carriers take advantage of opportunities to enhance their asset utilization.

Carriers can also use the DMS to enhance their asset utilization and to realize improved process efficiencies when locating shipper demand. Carriers facing “deadhead” or empty miles can use the DMS of the present invention to improve their asset utilization at a cost that is significantly less than the fees typically charged by brokers or third party logistics providers. Carriers also realize process efficiencies by using the system of the present invention to consolidate transaction information regarding their dealings with multiple shippers into one readily available source. Finally, the freight bill payment process of the system of the present invention may also provide carriers with improved payment times from shippers.

The database employed with the system of the present invention acts as a repository for capturing certain data for all transactions completed in connection with the present invention. Data will initially be grouped into categories of cost and pricing information, lane-of-traffic information, qualitative partner rating information, and cooperative buying profiles. The last category of data mentioned is intended to capture information regarding cooperative buying. It will be understood by those skilled in the art that the data can be organized differently to meet the needs of specific shippers and carriers, and will likely be reorganized for greater efficiencies over time.

The database will be automatically created as the DMS captures data in the desired categories. As a result, the value of the database to shippers and carriers will increase over time. Customers will be able to immediately analyze their own data. Once a critical mass of data is achieved, the database will enable customers to benchmark their data against averages contained in the database. The DMS of the present invention should enable the gathering of normative and comparative data on a scale and frequency currently not available to shippers and carriers using other systems and methods known in the art.

Another embodiment of the invention provides an interface that will enable shippers and carriers to aggregate their purchasing power to buy consumables regularly purchased by each group. For carriers, items purchased on a cooperative basis include, among other things, tires, fuel, and truck parts. For shippers, items purchased on a cooperative basis include, among other things, warehouse supplies.

The system also provides a customizable web page to those individuals and businesses visiting the web site. Known as the “myCarrierPoint™” web page, this feature will allow users to design a page that automatically delivers content available through the DMS in a form customized by the user. The myCarrierPoint™ web page is intended to serve as the primary mechanism for delivering planned content offerings to shippers, carriers, and others visiting the web site. Planned content includes, among other things, content from relevant industry publications, general news, weather information, and financial market information. Some content may, however, only be accessible to customers enrolled to use the DMS. In addition, the DMS of the present invention may also provide links between the web site and certain government and third party services that enable online regulatory compliance filing and reporting functionality.

The system of the present invention provides a marketplace that combines commerce, content and community to create a balanced value proposition for both shippers and carriers. Through the DMS, carriers will realize higher capacity utilization and enhanced market presence, while shippers will realize lower overall freight costs and enhanced service levels.

Reference will now be made in detail to the present preferred embodiments of the invention, examples of which are illustrated in the accompanying drawing figures. Wherever possible, the same reference characters will be used throughout the drawings to refer to the same or like parts.

The marketplace of the present invention can be created per individual shipper or carrier in various ways known to those skilled in the art. However, three specific markets created by different methods include a market created by the manual entry of market data of the market participants onto a DMS, a market created by the electronic submission of market data by market participants, a market created by the electronic capture of market data from market participants' remote business systems. An exemplary embodiment of the present system and method is a market created by manual data entry of market data. The market data can be accomplished with a series of web pages capable of data entry.

Registration

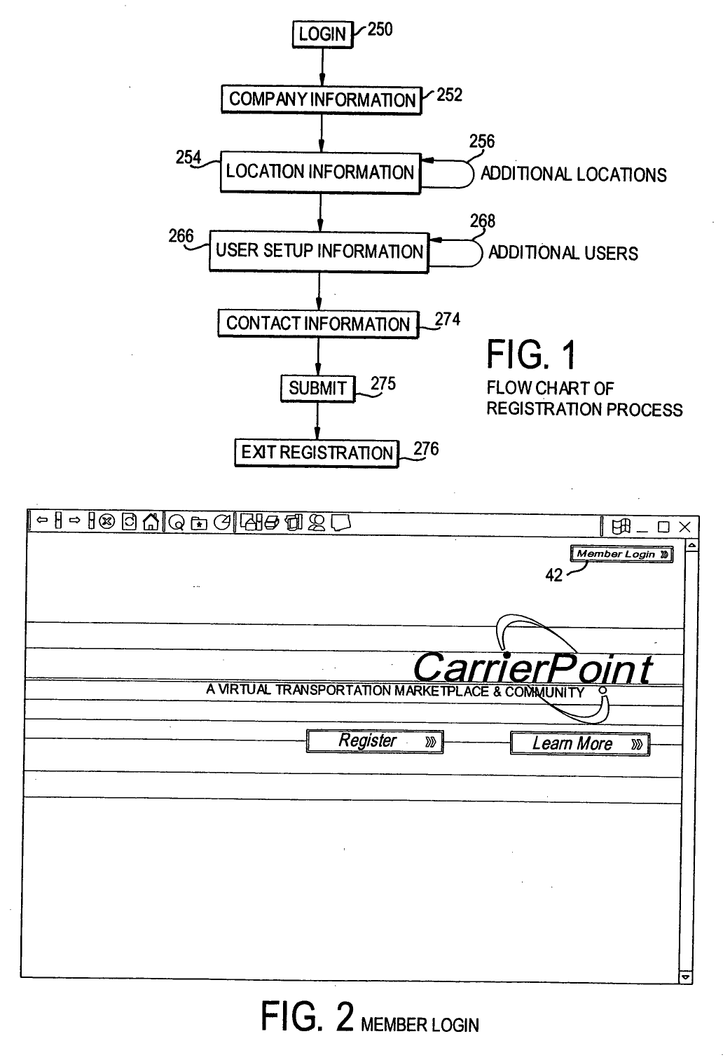

The registration process can be used to provide a security tier prior to its initial use by customers. The registration process is depicted in FIG. 1 with a process flow of steps whereby each step could be implemented as a web page. The first step in the present preferred system and method is the registration of a customer. The dynamics of the registration process differ in some respects according to whether the user is a carrier or a shipper. These aspects are distinguished in the following description.

Carrier and shipper registration information can be captured by the system either manually or electronically. In a preferred embodiment, the information is entered into the system via a series of web pages with various text fields, drop down lists and toggle buttons available for entry of the pertinent information.

The registration process in the present preferred method and system is described with reference to FIG. 1. A login step 250 can be provided as a front-end gateway to the registration process. This login process can be implemented in various ways known to those skilled in the art. Preferably, a user identification number and password is assigned to the individual or process that is entering the DMS in order to register a customer.

Once the login step is complete, the next step may be the Company information step 252. The company information step may be designed to capture parent company name and a Tax Identification Number. Further, this step may allow selection of whether the customer is a shipper or a carrier and may also capture other information specific to a carrier including, but not limited to, a Standard Carrier Alpha Code (SCAC), the motor carrier number, insurance information.

If the customer is a shipper the company information step 252, in addition, may be designed to capture additional information required due to the nature of a shipper. For example, a standard bill of lading tax, which is the transfer of liability of the product from the seller to the buyer, may be captures in this step. Further, this step may be designed to allow the shipper to select when to reveal the origin of shipments to the carrier, for example either prior to bidding by a carrier or after the bid is accepted, may be designed to allow the shipper to select when to reveal the destination of shipments to carriers, allowing the shipper to make these type designations, allows small shippers the flexibility of being anonymous so the market price obtained is not based on a company name, a company' reputation, or the size of the company.

The next step in the registration process may be designed to capture location information. This step is represented as the location information step 254. The location information step enables the capture of information pertaining to a company's subsidiaries or multiple distribution centers. Many carriers dispatch vehicles from a plurality of locations and have regional territories from which they dispatch. The physical address of a location, the billing address of the location, and the contact information for the specified location may be captured in this step. Further, information pertaining to “additional locations” can be captured in “additional locations” step 256 where the location information 254 step is repeated until all locations and corresponding information may be captured. Allowing this iterative step 256, accommodates those companies with subsidiaries multiple dispatch centers.

The next step in the registration process may be a user setup information step 266. This step may relate to an individual capturing data on those in the company that may be given access to the system as a user and to what location the user has access. A user setup information step can be designed to capture a user's first name, middle name, last name, and title in the company. Further, for security purposes, this step may be designed for the designation of a user identification and password. Additionally, this step can be designed to capture whether a user is in active or inactive status.

In a preferred embodiment, a user setup page may be designed to designate per user the security level associated with that user. For example, four initial user groups, such as Administrator designation having access to the entire system, location administrator designation having access to everything except the companies setup information, maintenance designation having access to configuration, and operations designation having access to peer review and marketplace, can be designated in order to implement a hierarchical security system.

If the customer is a carrier, then a user may be a driver. This step may further be designed to capture additional information. For instance, this step can capture a driver's license number, the State in which that license was issued, the expiration date of that license, and their social security number. The process need not confine the amount of users that may be associated to a company's account. An additional user step 268 may allow an iterative step providing a company to have limitless number of users.

The last step in the registration process may be a contact information step 274. This step may be designed to capture the required contact information per location. Contact information may pertain to the primary contact person at the company parent headquarters and the contact person at each location either at the headquarters, a subsidiary location or an additional dispatch center. If multiple locations for a company were captured in step 254, then this step may be designed to obtain the contact of each of the various locations designated in step 254. Information in step 254 can be captured in this step, including a contact name, name of who should be told when a partner company should be rated, the name of the contact that should receive hot notifications.

A hot notification is a notification mechanism that specifies notifications either via e-mail, cell phone text messaging or pager text messaging when specific events occur within the DMS. For a carrier, those events for which a carrier is notified include when a carrier is added to shipper's partner list when a shipment is posted that the carrier is qualified to post a bid on, or when a shipper accepts a carriers bid. For shippers the notification event is when they are added to a partner list.

Once a customer is registered to use the DMS, a customer, either a shipper or a carrier, is a member and can then access the DMS. A customer can use the DMS in one of several ways. A customer can employ an Internet connection and a browser and enter the data manually through a series of web pages. A customer may create a spreadsheet that conforms to a predetermined format and upload the data electronically. Lastly a customer can interface a remote system to the DMS over an Internet connection.

Manual Data Entry

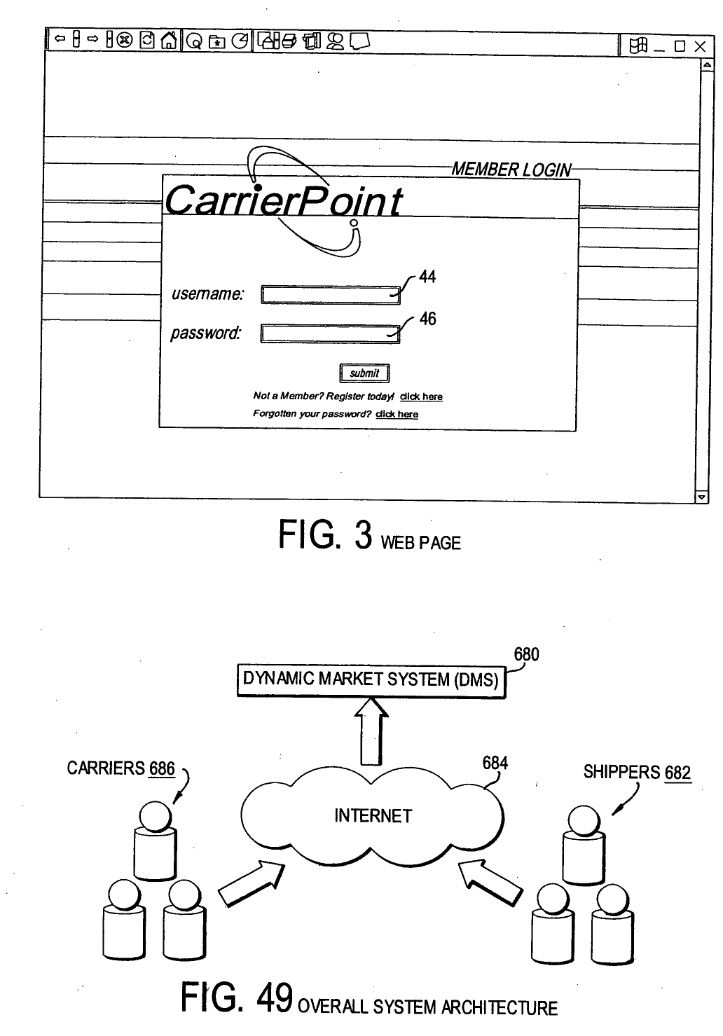

A customer can manually enter data onto the system using a series of web pages. In order to logon to the system via a web browser, a customer selects a designated web address where a “Member Login” web page (as represented by FIG. 2) is located. The user then selects Member Login button 42. Selection of button 42 prompts the display of a web page as represented in FIG. 3. The user then enters into the username text field 44 and the password text field 46, the user identification and password assigned to the customer.

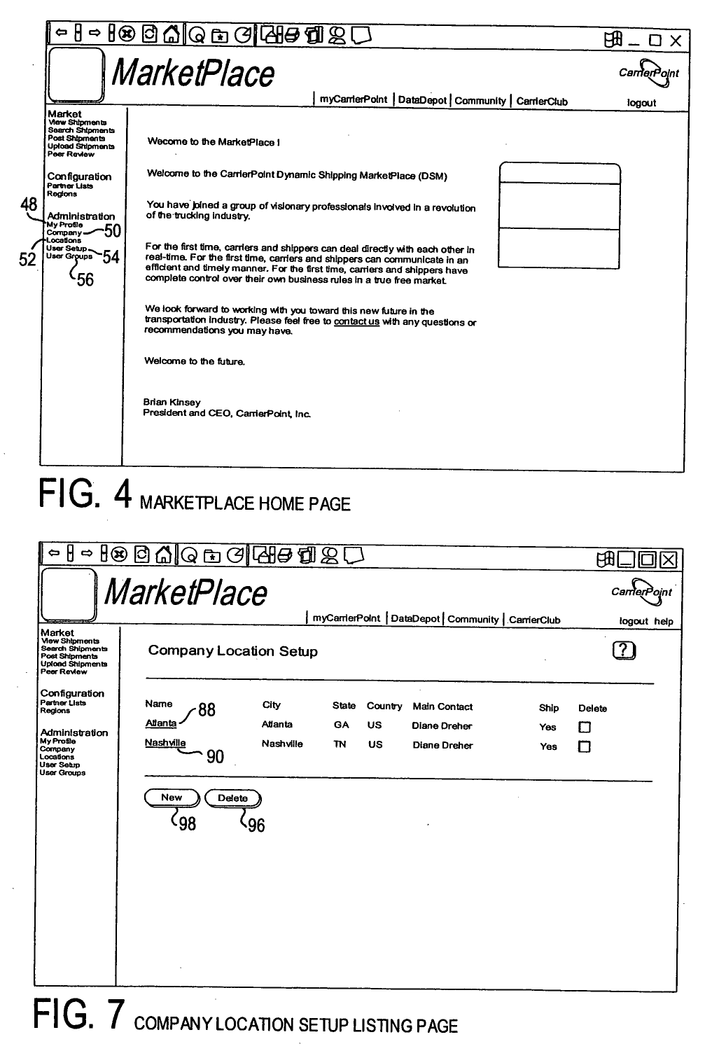

The “MarketPlace Home Page”, a representation of which is provided in FIG. 4, then displays a menu allowing a customer to access functional modules including, but not limited to, “Market,” “Configuration,” “Administration,” and “Peer review”, as will be discussed in greater detail below.

Administration

The “MarketPlace” home page illustrated in FIG. 4 provides five functional areas of the Administration functional module. These areas are accessed via the MarketPlace home page by clicking on one of the five hyperlinks “My Profile” 48, “Company” 50, “Locations” 52, “User Setup” 54, and “User Groups” 56.

My Profile

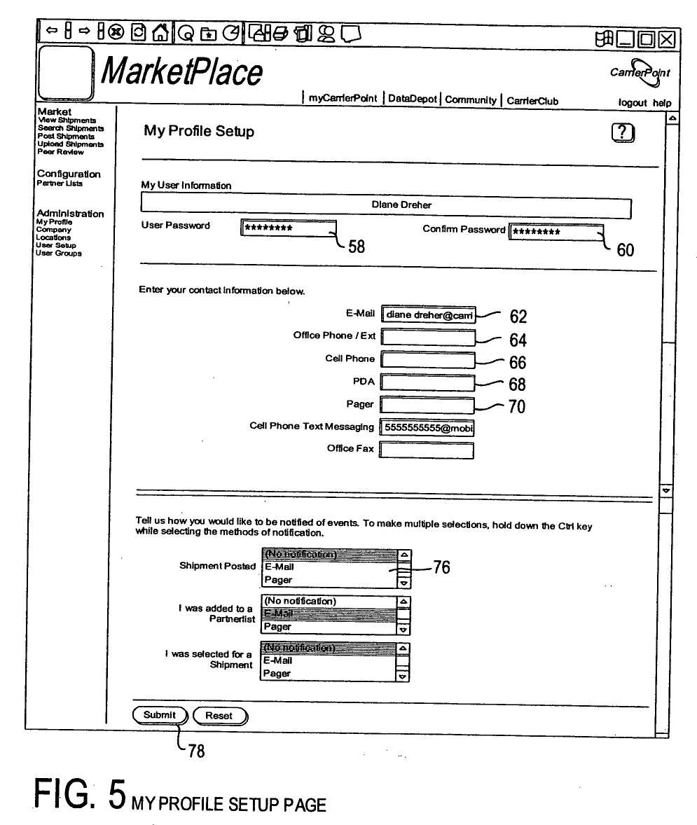

Selecting the “My Profile” 48 hyperlink in FIG. 4 displays a “My Profile Setup Page” as represented in FIG. 5. “My Profile” 48 allows each individual user within a company to have their own profile if desired. The system may allow for a company to have an infinite number of locations and an infinite number of users. Each user of the system has a login and password. Consequently, the system may provide each user with an individual configuration to enable user individuality in job description or simply preference.

The “My Profile Setup Page” can allow a user to change the user password by entering a new password in text field 58 and confirm the password in text field 60. Further, a user can enter contact information such as e-mail address in text field 62, office phone in text field 64, cell phone number in text field 66, PDA in text field 68, and pager number in text field 70.

The contact information in the “My Profile Setup Page” can be used by the system two separate ways. First, the system may use this information in conjunction with the notification mechanism in determining the mode of notification. Secondly, the contact information may also be displayed to carriers when they are bidding on a load posted by the user. This allows the shippers and carriers to communicate directly with each other.

The system can notify carrier users if a carrier is added to a partner list, if there is a bid a carrier can bid on, or if a carrier wins a bid. The system notifies shippers if they are added to a partner list. Therefore, if a user is designated as the person to be contacted at a location, the user can specify in the “My Profile Setup Page” how the notification is to occur. At the bottom the “My Profile” page each individual user sets up how the user wants to be notified. A shipper is notified only when that shipper is added to a partner list. A carrier is notified if added to a partner list, if a shipment is posted that the carrier can bid on, and when a carrier is selected for a shipment. The user can select from the scrolling window 76 to be notified by email, pager, cell phone messaging, and/or no notification. The user selects the “submit” button 78 to enter the data into the system.

Company Information

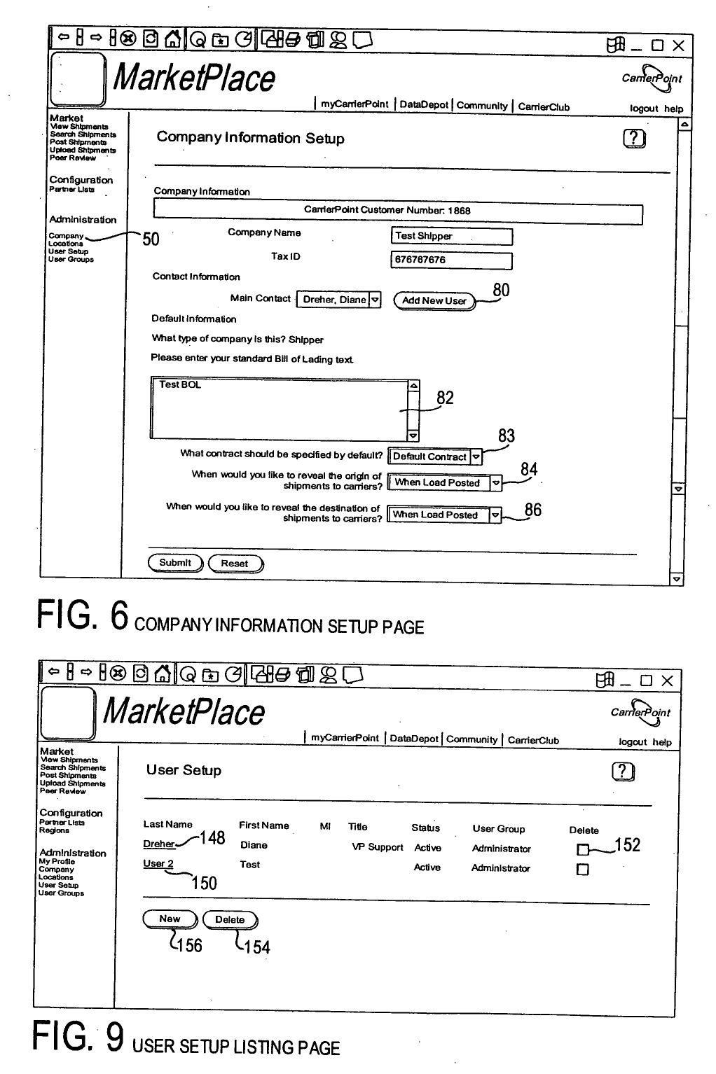

The company information will now be described with reference to FIG. 6. When a shipper selects the “Company” hyperlink 50, the web page as represented in FIG. 6 is displayed. The user can add a new user by selecting “add new user” push button 80 and set up additional users. This functionality is also available under “User Setup”, and is addressed in detail in that corresponding section. A shipper can choose to change the bill of lading text information by typing in to the scrolling text field 82 the new text desired. Finally, the “Company Information Setup Page” (FIG. 6) allows a user to select when to reveal the origin of shipments to carriers by providing a selection list 84 and when to reveal the destination of shipments to carriers by providing a selection list 86. If a carrier is the user, then a carrier can also designate which contract to use as a default contract by selecting from the pulldown list 83.

Company Location Setup

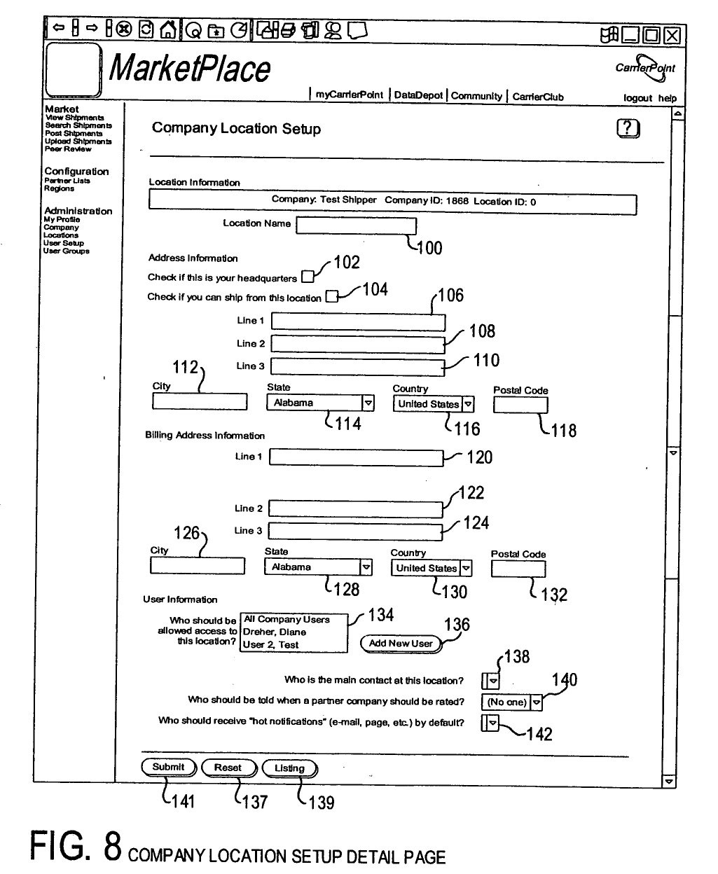

Selecting the “Locations” hyperlink 52 in FIG. 4 accesses the “Company Location Setup Listing Page.” The initial “Company Location Setup Listing Page” is illustrated in FIG. 7 with a list of example locations represented to the user as hyperlinks 88 and 90 (all possible location hyperlinks are not included). This list contains each of the locations that the current user has configured for the company. The user can delete a location by highlighting a location then selecting the “delete” button 96. A user can set up a new location by selecting the “new” button 98. Selecting 98 displays a “Company Location Setup Detail Page” screen as represented in FIG. 8.

For the new location the user enters the relevant information in the “Location Name” text field 100. The user can use selection boxes 102 and 104 to indicate if the new location is a headquarters or if shipping is available at the new location, respectively. Three address lines 106, 108 and 110 allow the user to enter the address information. Text field 112, pull down menus 114 and 116, and text field 118 allow the user to enter the city, state, country and postal code corresponding to the new location address. If the billing address information is different than the physical address of the new location, the user can enter the corresponding billing address in text fields 120, 122, 124, 126 and 132 and the pulldown menus 128 and 130.

With respect to the new location being added, the “Company Location Setup Detail Page” provides which users are given access to the new location. An existing user is selected from the scrolling list 134; or a new user is added to the company system by selecting the “add new user” button 136.

Lastly, the user can specify with pull down listing 138 who the main contact is at the new location. The user can specify with pull down listing 140 who is to be notified when a partner company is to be rated. Finally, the user can specify with pull down listing 142 who should receive hot notifications.

Once the new location information is entered, the user selects the “submit” pushbutton 141 to enter the new location. Alternatively, if the user does not want to enter the newly entered information, the user can select the “reset” pushbutton 137 that resets the information or the “Listing” pushbutton 139 that again displays the “Company Location Setup Listing Page” in FIG. 7.

User Setup

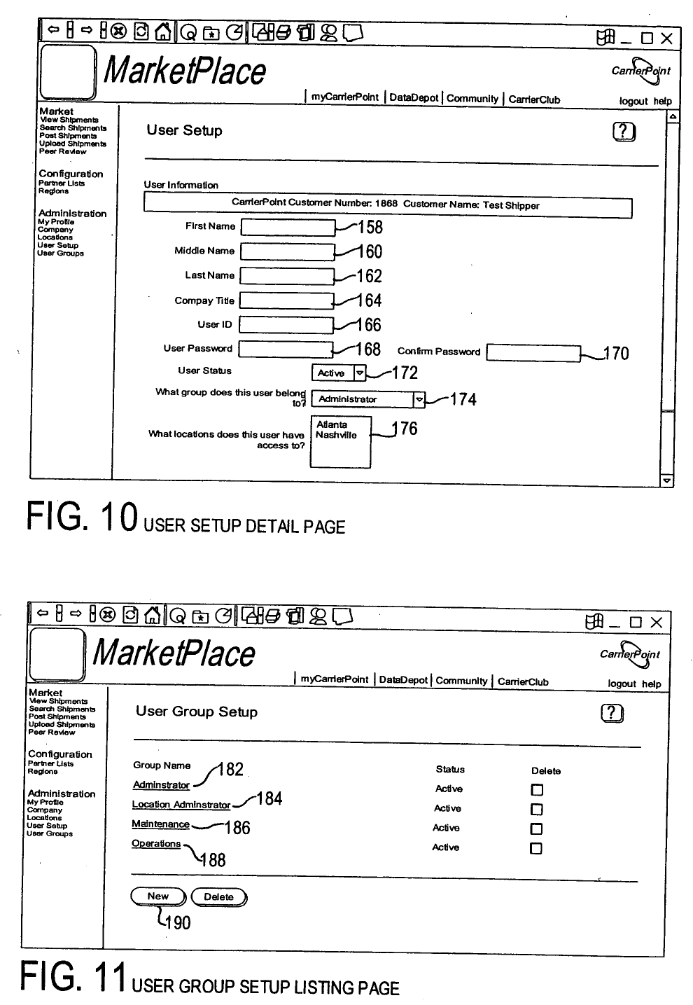

The “User Setup Listing Page” as represented by FIG. 9 is displayed when the user selects the hyperlink “User Setup” 54 (in FIG. 4). The display lists hyperlinks that correspond to every user in the company, for example 148 and 150. A user can be deleted by selecting check box 152 by the user name and selecting the “delete” button 154. A new user can be added by selecting the “new” button 156. Once the button 156 is selected, the web page as represented in FIG. 10 is displayed.

In the “User Setup Detail Page” in FIG. 10, a new user is created by first entering a first name in text field 158, a middle name in text field 160, a last name in text field 162, a company title in text field 164, a user ID in text field 166, and a password in text field 168. The user setup provides a status flag set by selecting active or inactive in the pull down listing 172. This option allows a user to be made inactive, for example, if the user leaves the company, goes on long term leave, or goes on maternity leave. Because the system is accessible by use of any we browser, security can mandate that access to a user on leave be made inactive.

Further, the user group associated with the new user is selected in the pull down menu 174. The system provides four (4) user groups. The system created groups include Administrator, Location Administrator, Maintenance, and Operations. However, as indicated in the following sub-section, a user can define user groups, and, if the user so chooses these groups appear also in the pull down menu 174. Finally, the user can specify which locations are accessible by the new user in the scrolling list 176. A user may work only at a subsidiary or dispatch center, in which case, the user only need access to that location.

User Groups

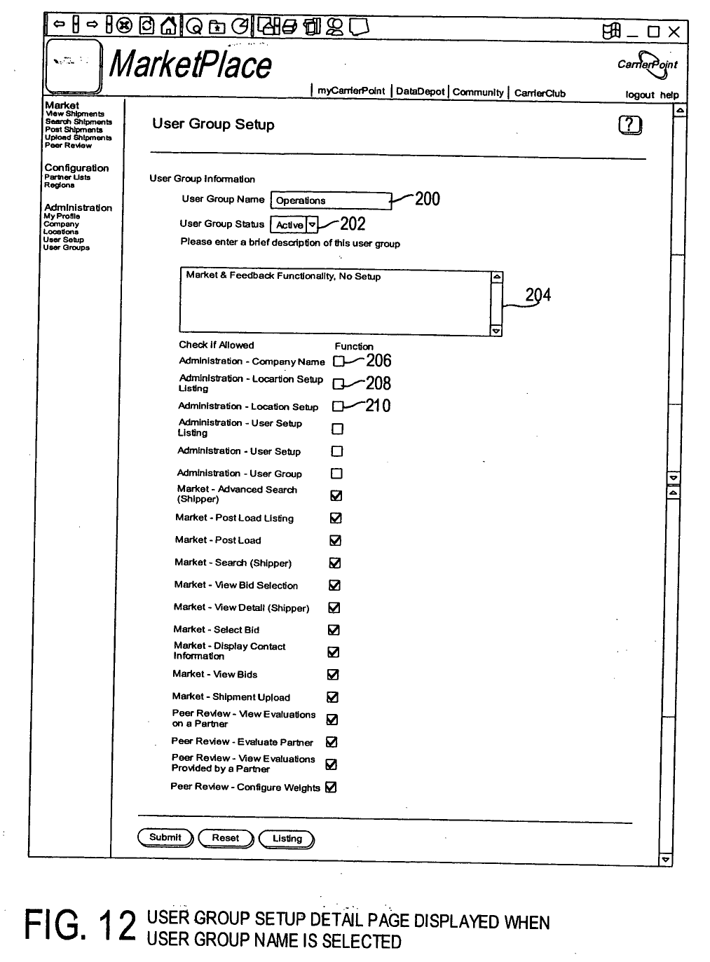

Lastly, the Administration module provides an area that a user accesses by selecting the “User Groups” hyperlink 56 (FIG. 4). The page displayed when selecting this hyperlink is shown in a representative web page in FIG. 11. This page displays the “User Groups Setup Listing Page” for this company which includes groups “Administrator” 182, “Location Administrator” 184, “Maintenance” 186, and “Operations” 188. Each of these user groups has associated with it a list of pages in the DMS that a user with that group designation can access. This is illustrated with reference to FIG. 12.

By selecting the Operations hyperlink 188 as shown in FIG. 11, the “User Group Setup Detail Page” page for “Operations” as represented in FIG. 12 is displayed. The text field 200 displays the name of the “User Group, Operations”, as selected from the listing in FIG. 11. The user group status is indicated as active or inactive in the pull down listing 202, and a description of the group is indicated in the scrolling window 204. Also, associated with the user group indicated in 200 as Operations is a listing of every page, for example 206, 208, and 210, within the DMS plus the addition of two options (an entire listing is not provided).

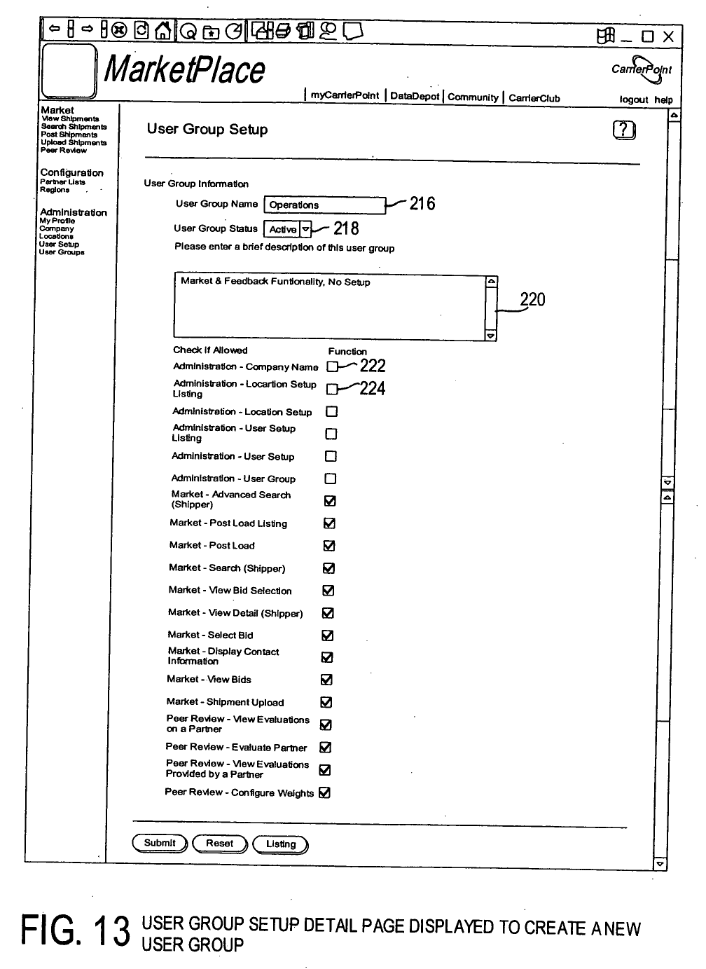

A new user group can be added by selecting the “new” button 190 (FIG. 11). A page such as the one represented in FIG. 13 is then displayed. The new user group name can be entered into text field 216. User group status is indicated by the pull down menu 218 as either active or inactive. The scrolling window 220 provides for entering a description of the new user group. Because security in the DMS is controlled on a page by page basis, below is a list of every page in the DMS. FIG. 13 provides an example listing of several pages including the “Administration-Company Setup” page 222 and the “Administration-Location Setup Listing” 224 (an entire listing is not provided, merely a sample listing). In order to designate to what page a new user has access, a check is placed in the page's corresponding check box. The user setting up the new user group simply checks each page that the new user group is allowed to access. If a page is not selected, then a user designated under the new user group type cannot access the page.

Configuration

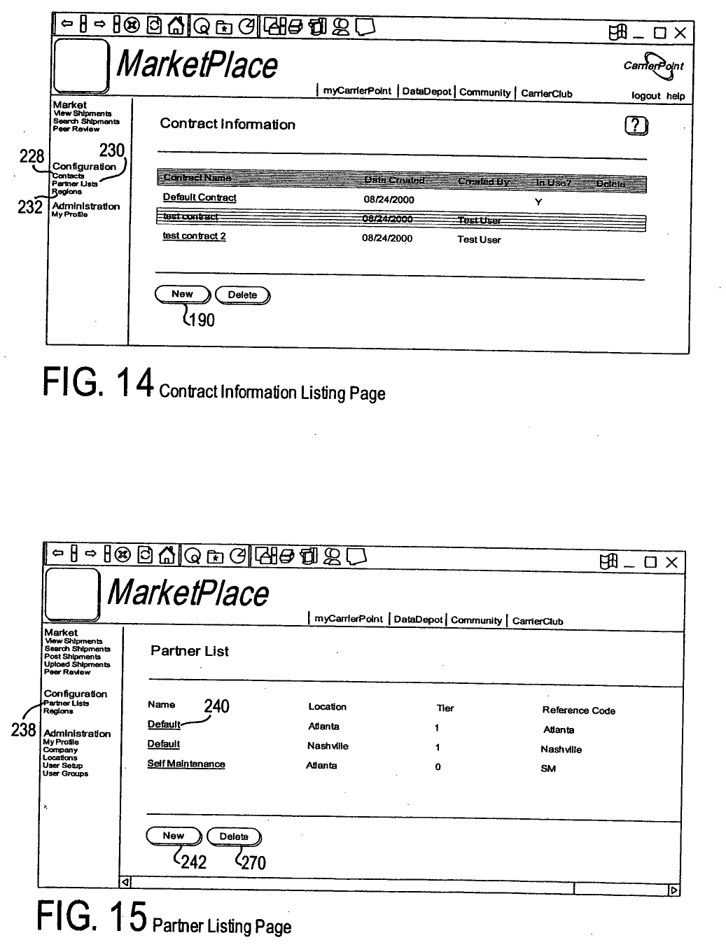

The “Configuration” module gives a customer the ability to set up the DMS to work with a customer's operations. The “Configuration” module provides for three areas of designation including 1) Contracts, 2) Partner Lists, and 3) Regions as indicated in FIG. 14 respectively as hyperlinks 228, 230, and 232.

Partner Lists

A partner list is one form of carrier access criteria. A shipper can associate with a single identifier a list of carriers. When a shipper posts a shipment to the system, the shipper can simply designate the identifier. Consequently, the shipment is only visible to those carriers on the Partner List. Specifically, partner lists confine the audience of a market. A partner list can be as broad as everyone within the marketplace, or as narrow as just one carrier within the marketplace. This is a factor that constitutes the shipper created market. Further, a partner list may be used by a carrier to exclude being notified of shipper postings, if the carrier desires not to do business with a specified shipper.

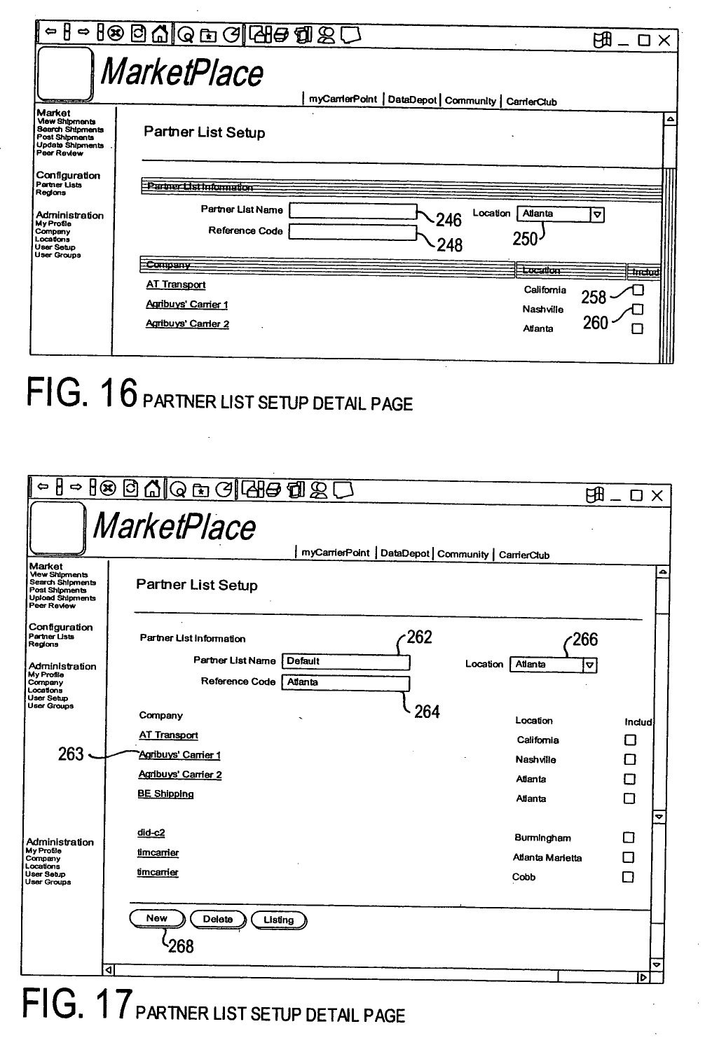

“Partner List” is an area of the “Configuration” module, and the “Partner List Listing Page” is illustrated in FIG. 15. A user selects hyperlink 238 and the “Partner List Listing Page” is displayed. A list is shown of hyperlinks to various partner lists. By way of example, a partner list named default is listed as a hyperlink 240 in FIG. 15.

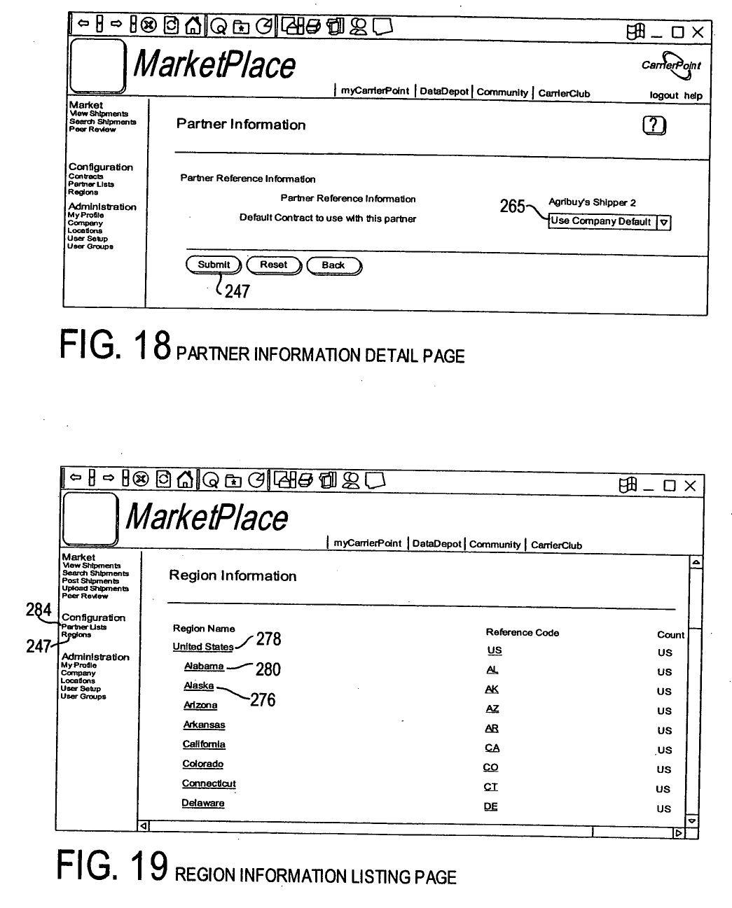

A shipper can set up partner lists to confine or limit the carriers available who they want to see a market. A carrier can set up partner list, to create an exemption list as to which posted shipments the carrier views. To create a partner list a user selects the “new” push button 242. The “Partner List Setup Detail Page” indicated in FIG. 16 is displayed. Text field 246 is designed to capture “Partner List Name” and text field 248 is to capture a “Reference Code”. Drop down menu 250 can allow specification to which location the new partner list relates. Creating the partners on the list can be accomplished by using one list of customers indicated below the company bar. Check boxes, for example, 258 and 260 are designed to indicate which partners in the entire list go on the new partner list.

A user selects a specific list hyperlink such as “Default” 240 in FIG. 15, and the “Partner List Setup Detail Page” as illustrated in FIG. 17 is displayed. This page allows the user to edit an existing partner list. Also with reference to FIG. 15, highlighting the list entry 240 and then selecting the “delete” push button 270 deletes the list.

In addition, A carrier can associate partners with a specific contract. By selecting the “Partner List Listing Page” hyperlink 238 (FIG. 15) a page as represented in FIG. 15 is displayed. Selecting a partner list such as “default” partner list hyperlink 240, a page as represented in FIG. 17 is displayed. This gives the carrier a listing of each of the shippers on the carrier's system. By selecting a shipper, for example selecting “Argibuys' Carrier1” hyperlink 263, the information on that shipper is displayed in the carrier “Partner Information Detail Page” as shown in FIG. 18. A carrier can then identify using the pulldown menu 265 to indicate which contract in the carrier's system to use as a default for the previously selected shipper.

Regions

By selecting the “Regions” hyperlink 247 (FIG. 19), the “Region Information Listing Page” is displayed as shown in FIG. 19. “Regions” give a shipper the ability to set up geographical regions within the United States, so that the shipper can have the ability to search for shipments that are posted.

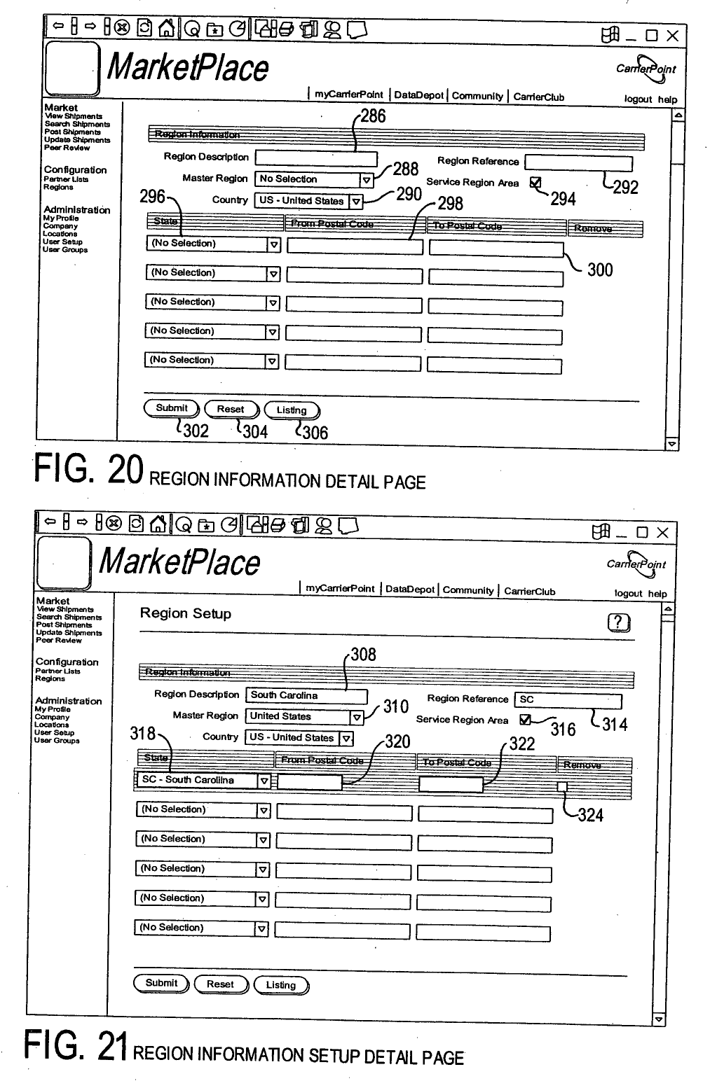

FIG. 19 shows a list of regions that is created by default with a United States hyperlink 278 and a list of the 50 states as subregions. For example, hyperlink Alabama 280 and hyperlink Alaska 276 are subregions of the United States region. Selecting a hyperlink in the list displays the screen as shown in FIG. 20, the “Region Information Detail Page.”

This web page captures data necessary to create a service region. Text field 286 captures region name, and text field 292 captures region reference. Pull down list 296 and text fields 298 and 300 allow the user to define the region serviced. Once completed the user selects the submit button 302 to add the region to the system.

A user can further edit an existing region by selecting a region hyperlink, for example in FIG. 19 Alabama hyperlink 280. A “Region Information Detail Setup Page” as shown in FIG. 21 can be displayed to edit a region. A user can change the region description text field 308, the reference 314 and the zip codes serviced 320 and 322.

The region functionality serves a dual purpose. The regions functionality allows a shipper to search regions and group regions in order to determine markets created by the shipper. The carrier can use the regions functionality to look for posted shipments in the company's serviceable area(s).

Peer Review

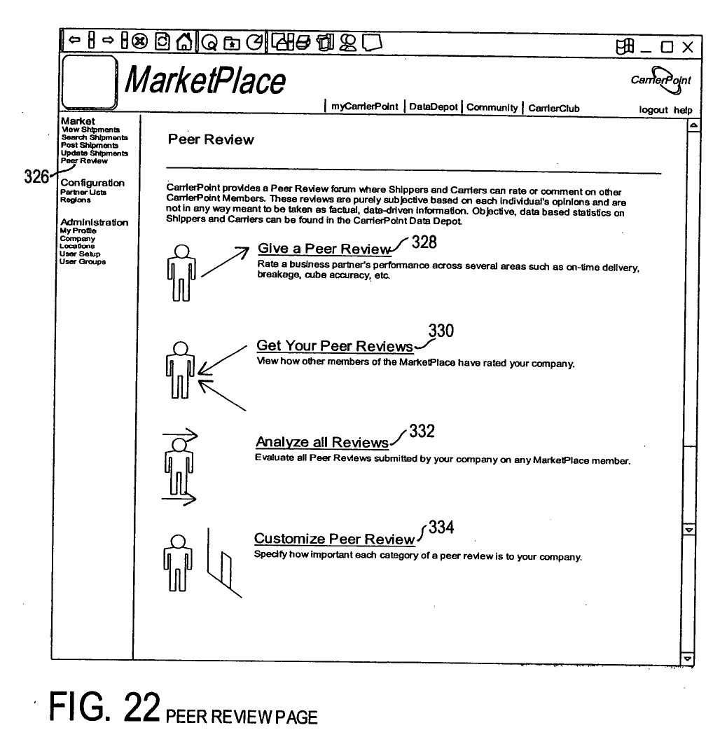

With reference to FIG. 22, by selecting the “Peer Review” hyperlink 326 a user can enter the “Peer Review Page” as shown in FIG. 22. The peer review system is opinion-based on a scale of predefined elements that we set up for shippers and carriers. Each predefined element has an associated scale of 1 to 5.

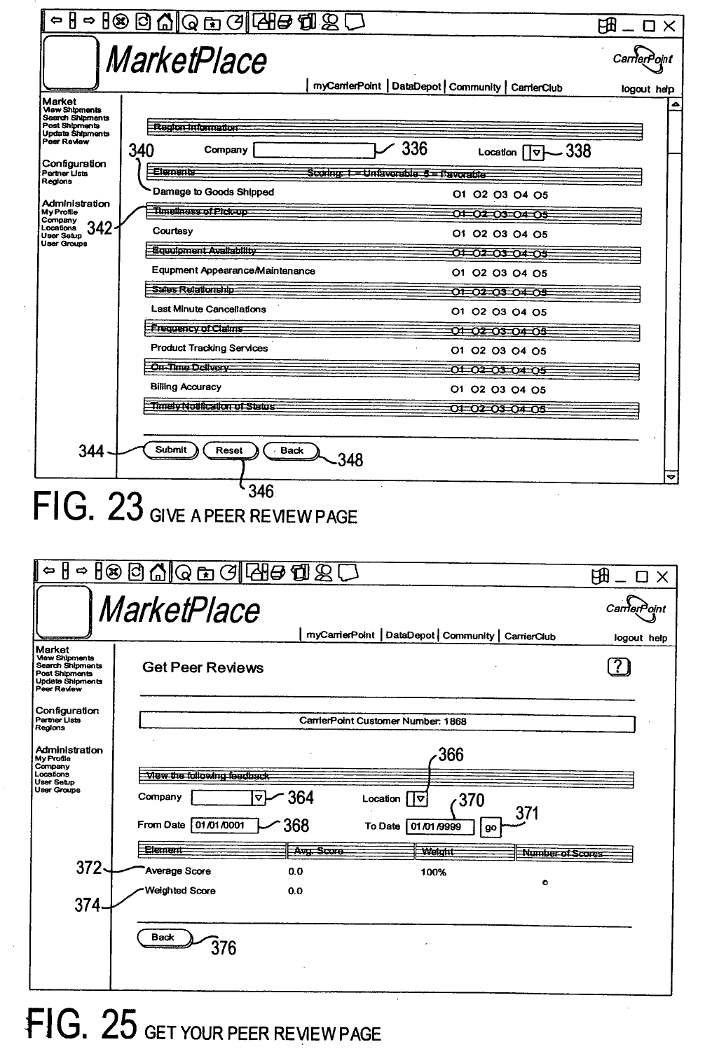

A user of the system can give a peer review by selecting hyperlink 328 which displays the “Give a Peer Review Page” as shown in FIG. 23. In the “Company” text field 336, the user indicates which company the user is planning to review. The user can give a review based on all locations or a particular location. The user can select which location to review from the location pull down menu 338. The user then selects a number from 1 to 5, 1 being unfavorable and 5 being favorable, relative to each of the elements. The elements listed, for example, can include such things as “damage to goods shipped” 340 and “timeliness of pick-up” 342. Once the user has completed the rating selecting the “submit” button 344 sends the data to the system.

By selecting hyperlink 330 in FIG. 22, the “Get Your Peer Review Page” is displayed as in FIG. 25. This area of “Peer Review” allows a customer to obtain reviews of its company. A user can receive from the system peer reviews by entering into the company text field 364 a company name or selecting a company from the pull down list. Further, the user can indicate the precise location on which the user wants to obtain the scores by indicating the location in the Location pull down menu 366. The user can also indicate a date range in the “from date” text field 368 and the “to date” text field 370, then select the go push button 371. The system then retrieves the information requested, and the data is displayed as indicated as an “average score” 372 and as a “weighted score” 374.

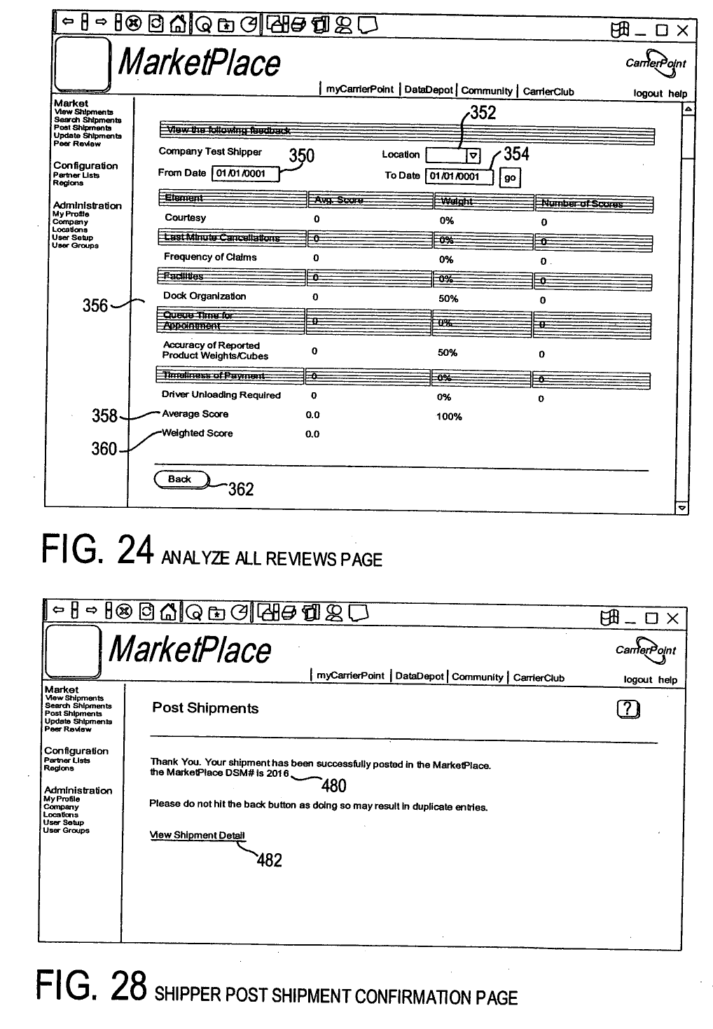

By selecting hyperlink 332 in FIG. 22, the “Analyze All Reviews Page” is displayed as represented in FIG. 24. This area of the Peer Review module allows a customer to search on the reviews given to other companies. Currently you can only search to see the information that has been provided to your company from other people or reviews provided by your company to other companies. As indicated in FIG. 24, the information is displayed as a series of total averages. The information is also displayed as a series of weighted averages.

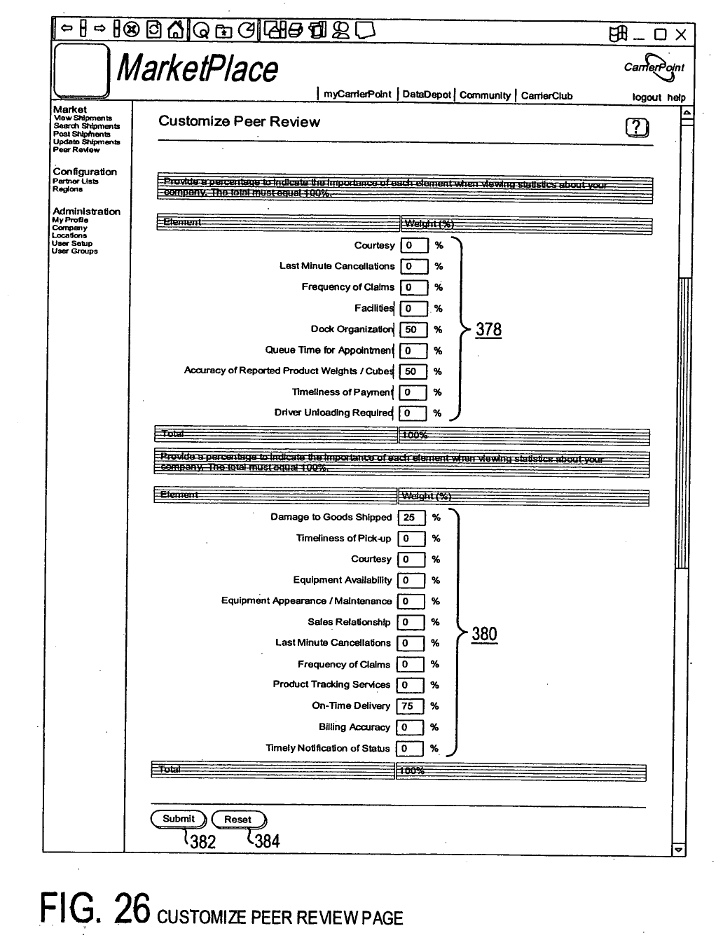

By selecting hyperlink 334 in FIG. 22, the “Customize Peer Review Page” is displayed as represented in FIG. 26. This area of the “Peer Review” module allows a customer to set up weighting information on the business variables in light of what is important to the customer's company. Therefore, the user who is to view information received from customers defines how the data is viewed.

“Customize Peer Review”, gives a user the ability to correspond to predefined elements a percentage relating to the importance each user places on each of the predefined elements. Two separate lists are defined in FIG. 26. The first is list 378 where a user indicates the importance of each element when viewing statistics about the user's company. This list can include, but is not limited to, courtesy, last minute cancellations, and frequency of claims (the entire list is not repeated here). A user can indicate in the text fields corresponding to the elements a weighted percentage of importance to the user of the element.

The second is list 380 where a user indicates the importance of each element when viewing statistics about a partner's company. This list can include, but is not limited to, damage to goods, timeliness, and courtesy (the entire list is not repeated here). A user can indicate in the text fields corresponding to the elements a weighted percentage of importance to the user of the element in day to day business.

Each list, list 378 and list 380, is defined by the user of the system. This allows users with different job functions in a company to view data necessary for the analysis of his/her job.

Market

Shipper/Post a Shipment

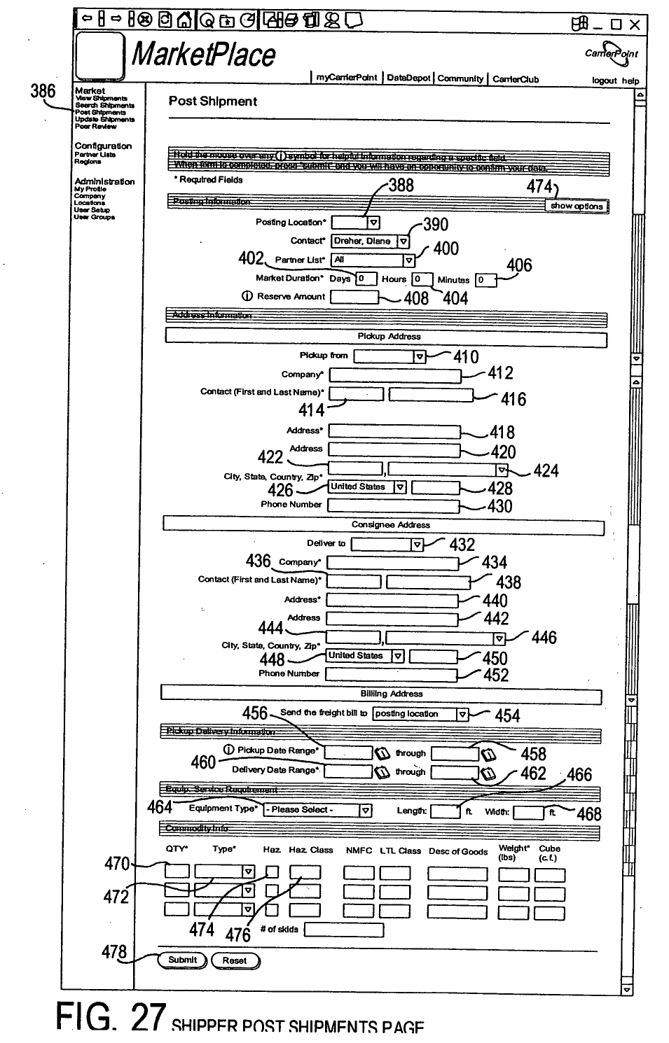

Selecting the “Post Shipment” hyperlink 386 in FIG. 27 displays the “Shipper Post Shipment Page” as indicated. This page allows a user to post a shipment directly onto the site. This web page contains various text fields and pull down menus that allow a user to designate multiple aspects for a shipment that is being posted. However, the quantity of data captured on this page is not limited to only that data shown.

The first block of information is “Posting Information”. Information entered under the “Posting Information” includes but is not limited to posting location 388, contact information 390, partner list selection 400, duration of the market in days 402, hours 404, and minutes 406, and a reserve amount 408. The “Reserve Amount” is the indicates the dollar amount the freight normally costs the user or the high amount that the user is willing to pay to have the freight carried.

The “Show Options” button 474 displays further fields that are optional to the shipper under the “Posting Information” data block. For example, a shipper can post a shipment to bid on in the future, and the user can enter this type of additional information by selecting the show options button. Other optional information can include, but is not limited to, Customer Number, Order Number, Purchase Order Number, Bill of Lading Number and other reference numbers that are not required fields but are useful to customers for tracking.

The next block of information on the “Post Shipment” page is “Address Information” including but not limited to the pickup address, the consignee address, and the bill to address. The pickup address information allows a user to select a location from which to pick up the shipment. The user enters information such as pickup from 410, company 412, address 418, and 420, and phone number 430. Consignee information includes where the freight is to be delivered, if it is not a shipper location.

The billing address allows the user to select where to be billed. The “send the freight bill to” pull down menu 454 provides sending the bill to either the postal location, the company, the pickup address or a third party.

The next block of data relates to pickup/delivery information. “Pickup date range” text field 456 and through text field 458 captures the date range in which the user wants the package to be picked up. Correspondingly, “delivery date range” 460 and “through” text field 462 captures the date range in which the user wants the pack delivered. In a preferred embodiment a calendar feature allows the user to view an interactive calendar to select the dates.

The next block provides the user an “equipment type” pull down list 464 to indicate type of equipment requirements for the shipment and a “length” text field 466 and a “width” text field 468 to capture size requirement of the equipment.

The last block of information allows a user to enter commodity information. This includes, but is not limited to, the quantity of goods, 470, the type of goods, 472, hazardous 474, and hazardous class 476.

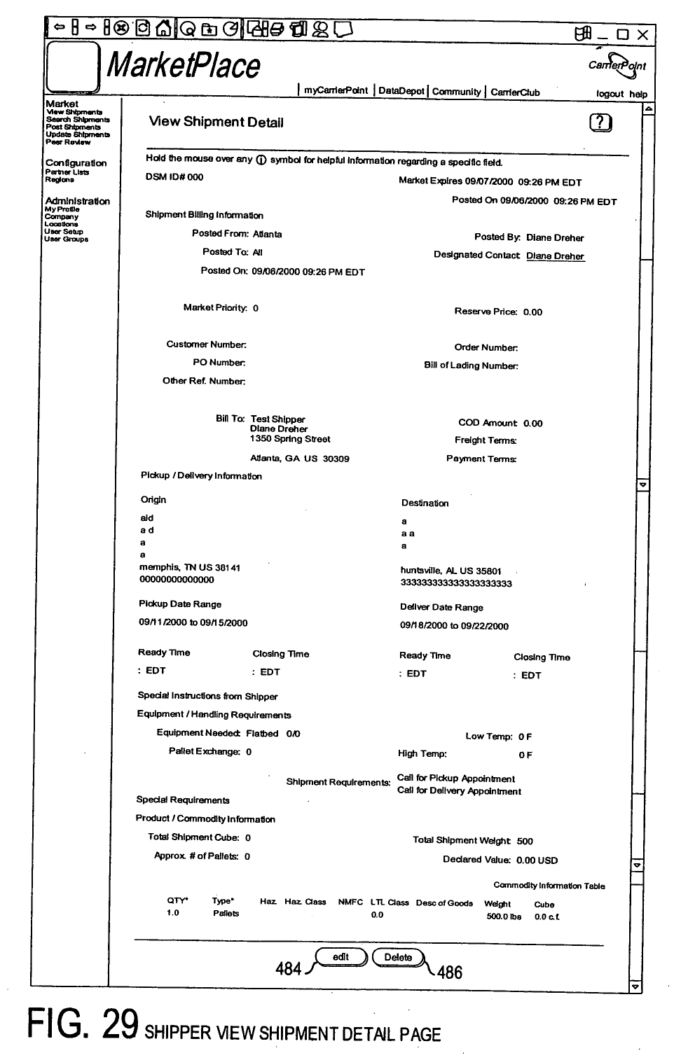

Once the user selects the “submit” push button 478, the shipment is posted to the system. This in turn displays the shipper “Post Shipment Confirmation Page” illustrated in FIG. 28. The DSM number 480 is displayed, and this number is the tracking number for the system. Further, from this page the user can select the view shipment detail hyperlink 482 which links to the shipper “Shipper View Shipment Detail Page” as represented by FIG. 29.

FIG. 29 displays to the shipper the details of the shipment posted. From this page the user can edit the shipment by selecting the “edit” push button 484 or the “delete” push button 486. The system allows a shipper to edit or delete a shipment until at least one carrier has bid on it. Once a carrier has bid on the shipment, it can no longer be edited.

Search Shipments

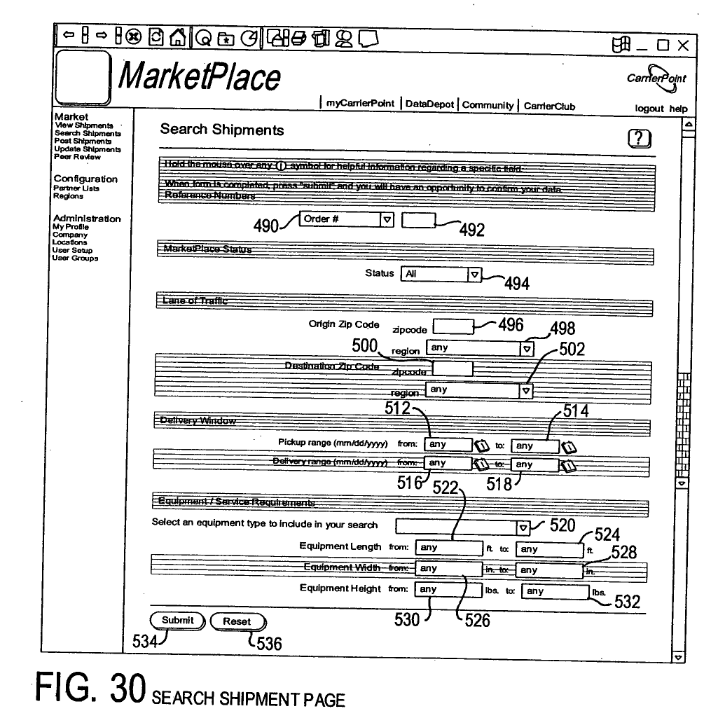

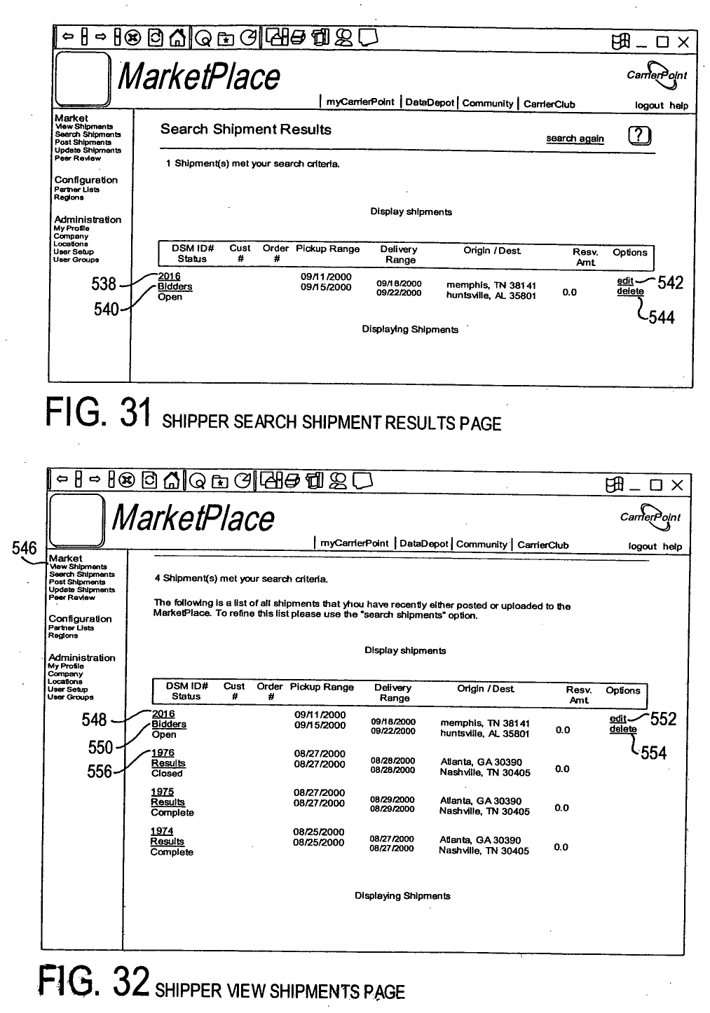

FIG. 30 is a representative “Search Shipment Page” displayed by selecting hyperlink 488. A shipper can search for a shipment based on order number, customer number, bill of lading, or DMS number, which the user can select from the pulldown list 490 and enter the corresponding number in the text field 492. After selecting criteria on which to search the user selects “submit” push button 534, and a “Shipper Search Shipment Results” page as shown in FIG. 31 is displayed.

FIG. 31 represents information displayed to the user after a search is performed by the system. The DSM number hyperlink 538 when selected provides a view shipment detail screen where the user can edit or delete the shipment. A “bidders” hyperlink 540, when selected, displays a list of carriers who have bid on the shipment. The “edit” hyperlink 542 displays the post shipment screen and allows the user to edit the shipment details. The “delete” hyperlink 544 allows the user to delete the shipment. Furthermore, the user can search based on status, lane of traffic, origin zip code, and destination code. Lastly, a carrier can search for shipments on bid status. For instance, a carrier can search on shipments that the carrier has bid on, shipments carrier has been selected to ship, or shipments the carrier has not been selected to ship.

View Shipments

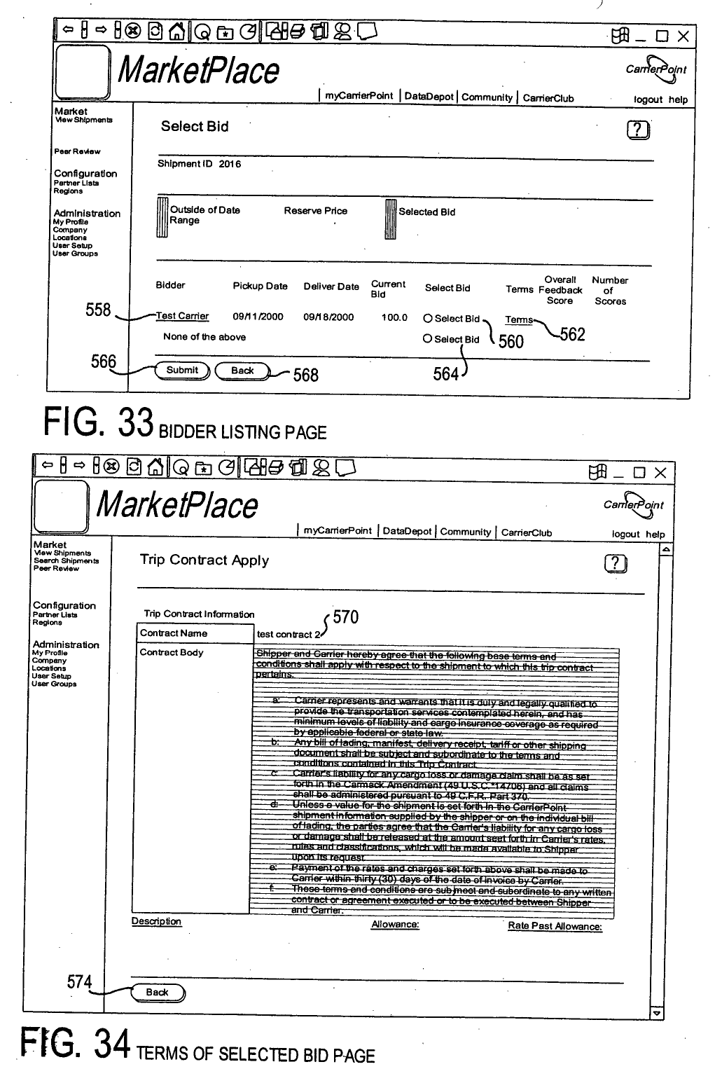

FIG. 32 is a “View Shipments Listing Page” that can be used to display to carriers or shippers a listing of all shipments that that may have resulted from a search request. This screen is displayed either when a user (either shipper or carrier) selects the “View Shipments” hyperlink 546 or as a result of a search request. By selecting the “View Shipment” hyperlink 546 either from a carrier market or a shipper market, the list as presented in FIG. 32 is displayed. If a shipper is presented the list as a result of a “view shipments” selection or as a result of a search request, the shipper has the option to select the “edit” pushbutton 552 or the “delete” pushbutton 554. The “edit” functionality allows the shipper to change the parameters of the shipment, and the “delete” functionality allows the shipper to delete the shipment. In addition, a “Bidder” link 550 when selected displays a “Bidder Listing Page” as represented in FIG. 33.

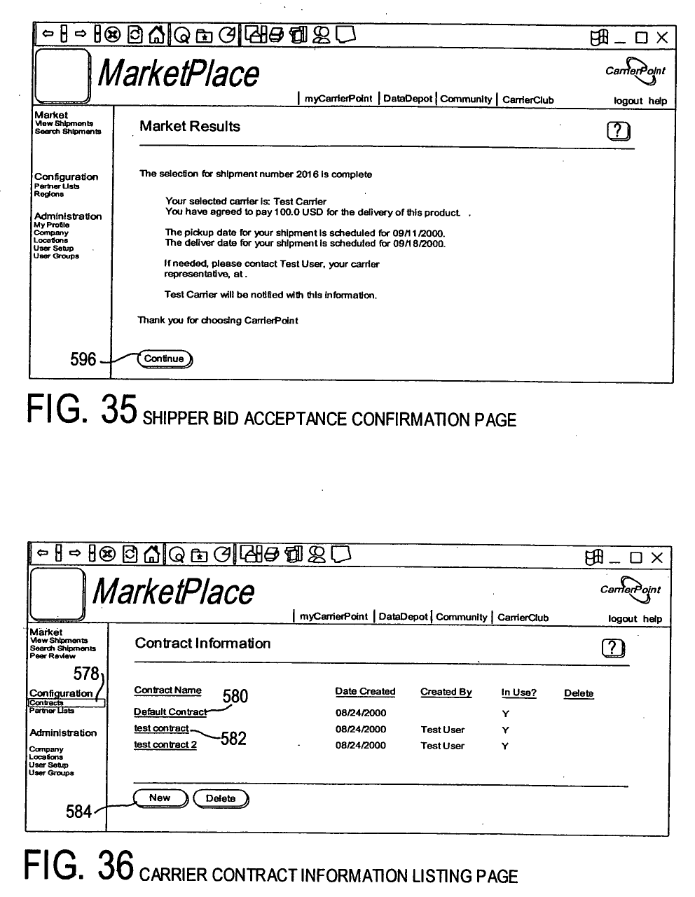

The representative page in FIG. 33 allows a user to first view the contact information on the bidder by selecting hyperlink 558. The user can select the toggle button select bid 560 that indicates that the shipper accepts the carriers bid on the terms as indicated. The “Terms of Selected Bid Page” in FIG. 34 can be viewed when a shipper selects the “term” hyperlink 562 (FIG. 33). As indicated by the “select bid” toggle button 564 (FIG. 33) the user can select none of the above. The shipper is not committed to accept a carrier that has placed a bid. The user can now press submit button 566 (FIG. 33) and receive the “Shipper Bid Acceptance Confirmation Page” in FIG. 35. The carrier will get notified via e-mail, cell phone, text messaging, or paging, once the user selects “submit” push button 566 (FIG. 33).

Carrier Market Contracts

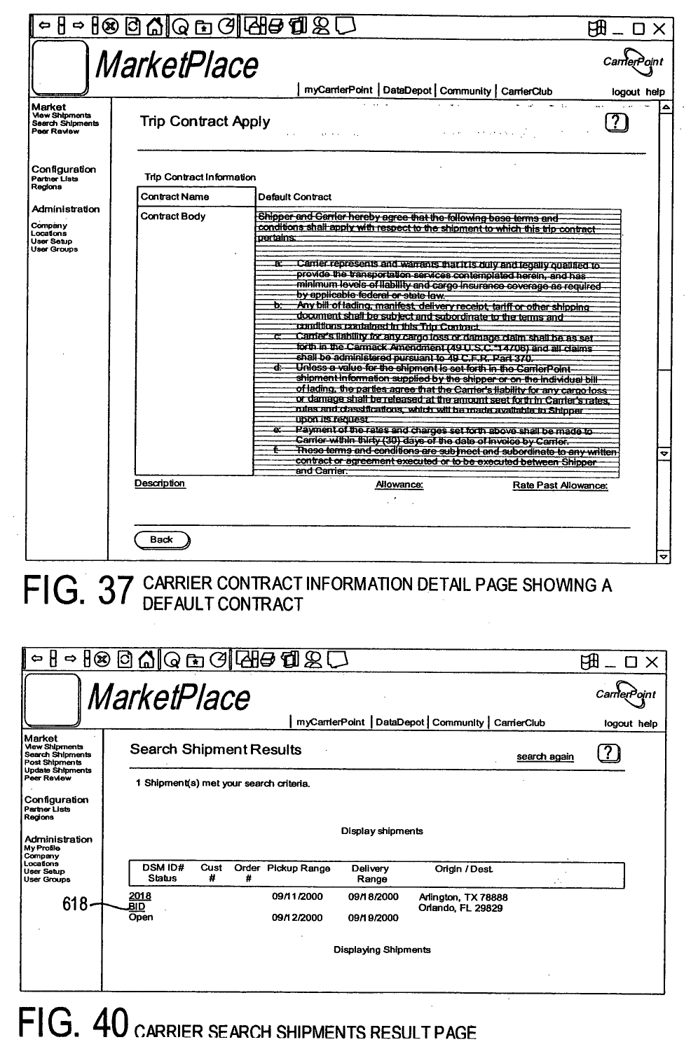

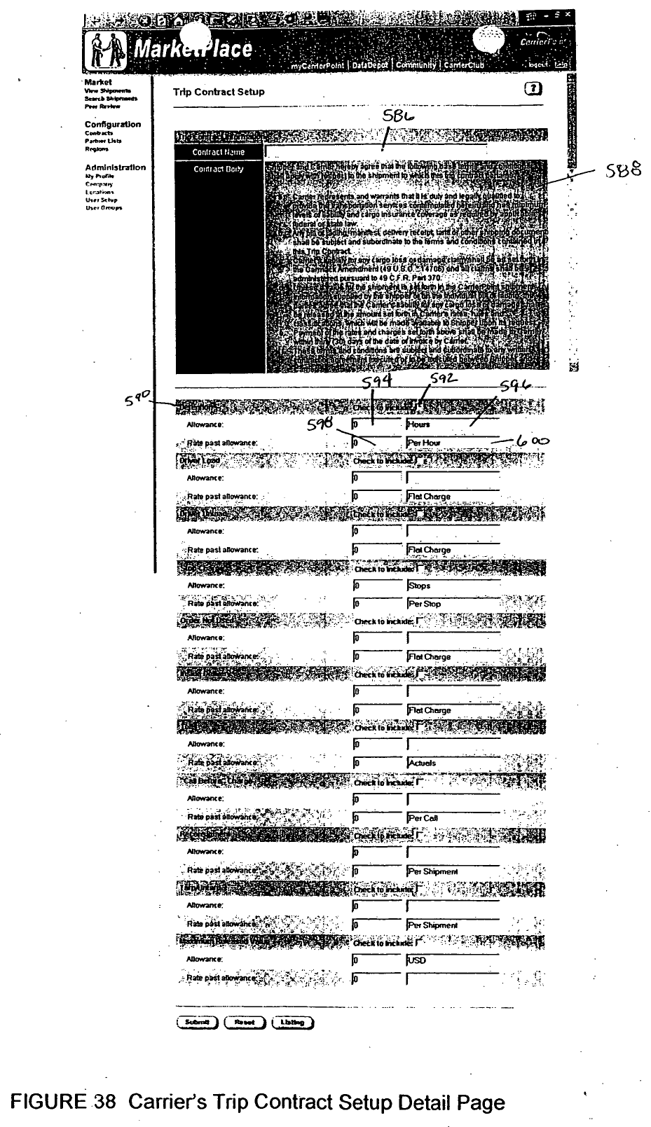

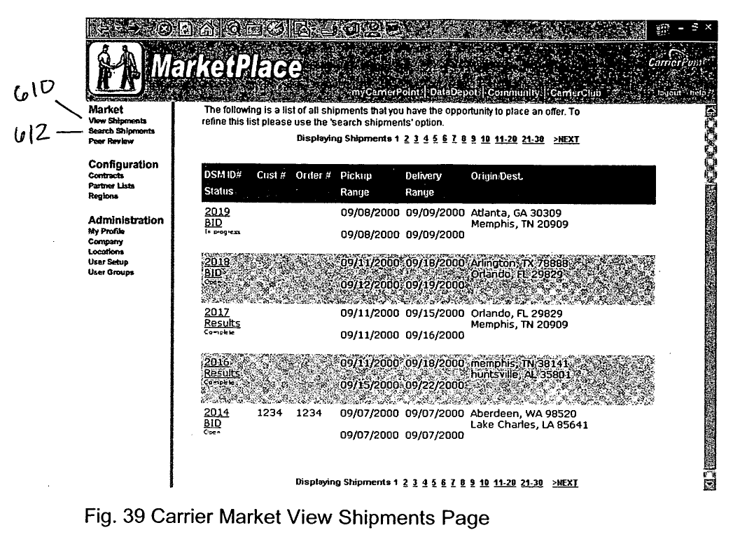

In the carrier market, a carrier has contract options. By selecting the “contracts” hyperlink 578 (FIG. 36), a “Carrier Contract Information Listing Page” as shown in FIG. 36 is displayed. The default contract that is provided at registration can be viewed by selecting the “Default Contract” hyperlink 580. A “Contract Information Detail Page” is displayed as represented in FIG. 37. A contract is in use because a market has been completed or bid on with a contract. When a user selects “new” hyperlink 584 in FIG. 36, the “Carrier Trip Contract Setup Detail Page” is displayed as represented in FIG. 38. The standard verbiage 588 is provided and a listing of available assessorial charges are provided including, for example, “Detention” 590. Assessorial charges can include but are not limited to detention, driver load, driver unload, and stop charges. An assessorial charge is added to the default by selecting a check box 592, an allowance rate 594, allowance hours 596, rate past allowance 598, and rate (per hour . . . etc.) 600. This process allows a user to create a specific contract that may apply to only a specific customer.

Bidding

There are two ways in which a carrier can place a bid. By selecting the “Carrier Market View Shipment Listing Page,” as shown in FIG. 39, a carrier can either place a bid by first selecting the “View Shipments” hyperlink 610 or second by selecting the “Search Shipments” hyperlink 612.

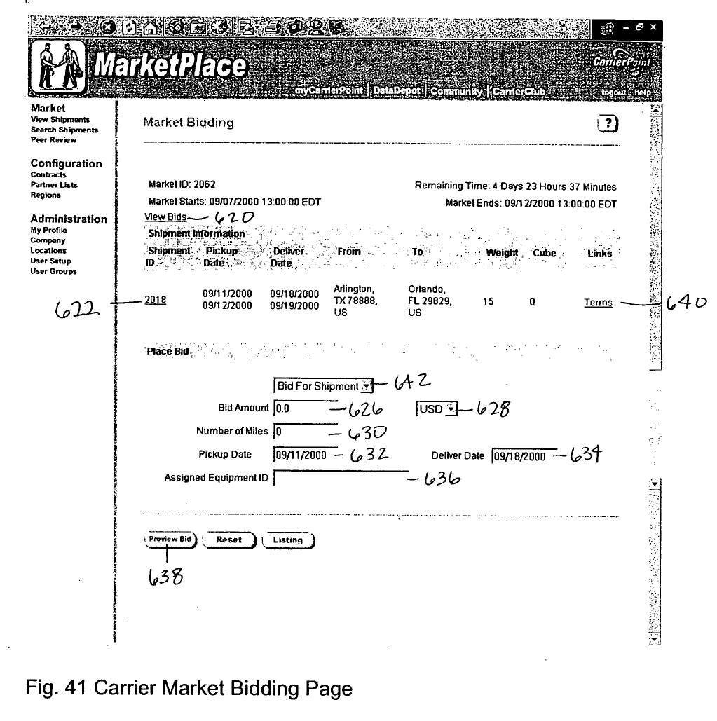

By selecting “View Shipments”, hyperlink 610, a carrier “Carrier Search Shipment Result Page” as represented in FIG. 40 is displayed. A carrier can then select the bid hyperlink 618. The “bid” hyperlink selection displays a “Carrier Market Bidding Page” as represented in FIG. 41.

By selecting hyperlink 612 (FIG. 39), a “Search Shipment Page” as represented by the page as shown in FIG. 30. The carrier can search available shipments by selecting or entering specific criteria, then selecting the “Submit” push button 534. Once “submit” is selected the results are displayed to the carrier as in FIG. 40. The carrier can select hyperlink 618 to bid on a shipment. Once a carrier has selected the “Bid” hyperlink 618 a “Carrier Market Bidding Page” is displayed as shown in FIG. 41.

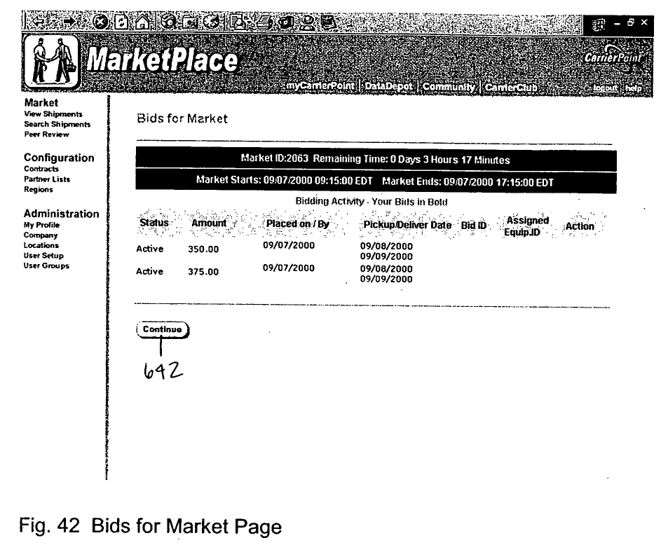

A carrier can view bids of each carrier who has placed a bid on a shipment by selecting the “View Bids” push button 620, the “View Bids” selection displays the “Bids for Market Listing Page” as shown in FIG. 42. This screen allows the carrier to view bids in a market. In FIG. 41, a carrier can view the detailed information of the shipment by selecting a hyperlink 622 or view the terms of the contract by selecting hyperlink 640. If bids on a flat rate the carrier enters the bid amount in text field 626. The carrier can change the “pickup date” 632, or “delivery date” 634. If the carrier has equipment, a trailer, or a power unit ID that is being tracked to pickup shipment that would be picking up in there. The carrier can place this ID in text field 636.

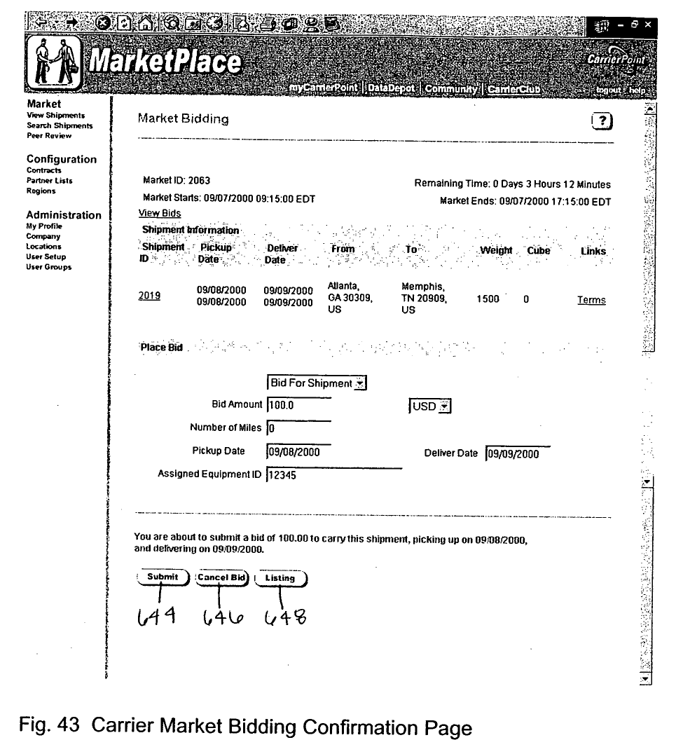

After the carrier enters the required bidding information, the carrier then selects the “preview bid” push button 638 in FIG. 41. The “Carrier Market Bidding Confirmation Page” in FIG. 43 is displayed. In order to place the bid, the carrier selects the submit push button 644. The carrier can also cancel the bid by selecting the “cancel” push button 646 or return to the view shipment or search result listings by selecting the “listing” push button 648.

Shipper's Market Bid Notification

A shipper is notified through the “View Shipments” functionality in the shippers market. A “Shipper View Shipment Listing Page” is illustrated in FIG. 32. A shipper can select the “bidders” hyperlink 550 that displays a page as represented in FIG. 33. A carrier can select the “Select Bid” toggle 560 to accept the bid or the “select bid” toggle 564 to select None. Also, as long as the market remains open the carrier can select the “Back” push button and wait for further bidding. If accepted, a “Shipper Bid Acceptance Confirmation Page” as shown in FIG. 35 is displayed.

Carrier Market/Acceptance Notification

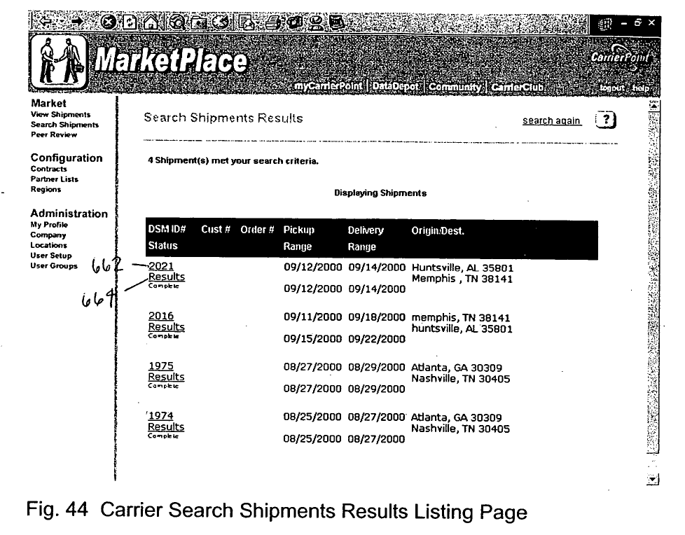

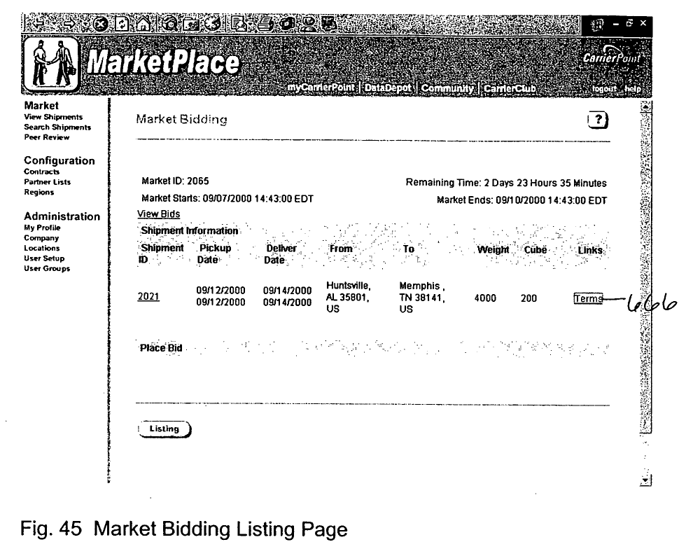

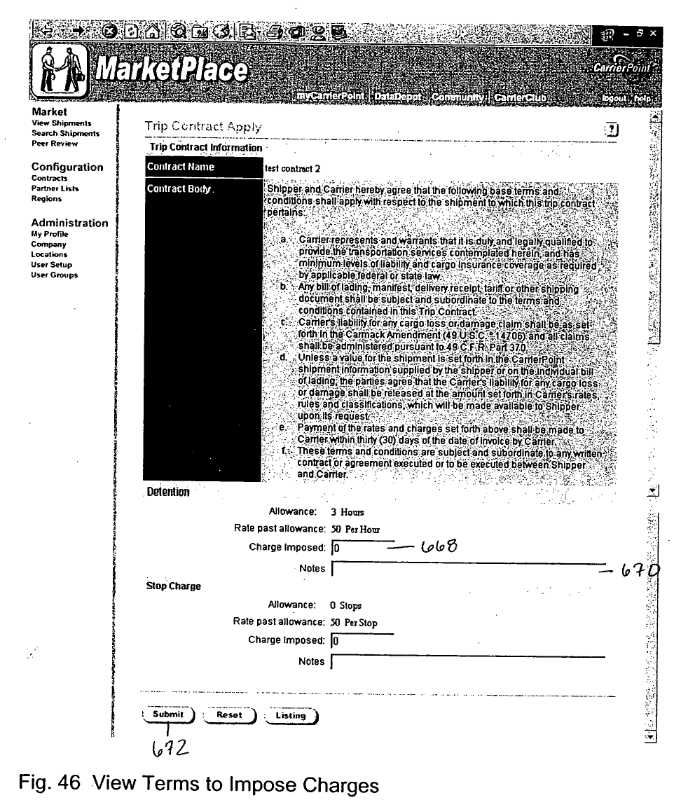

Once a bid is accepted, a carrier can be notified either via e-mail, pager, cell phone or any other way known in the art. When a carrier enters the system after the shipper has submitted the acceptance, a carrier can perform a search on the system to retrieve the shipment details of the accepted bid. A “Search Shipments Page” is illustrated in FIG. 30. A carrier can search on varying criteria including but not limited to bid status. The search results are displayed to the carrier by the “Carrier Search Shipment Results Listing Page” in FIG. 44. A carrier can select the “results” hyperlink 664 and the various bids are listed in the carrier “Market Bidding Listing Page” in FIG. 45. The carrier can then select the “terms” hyperlink 666 to view the contract terms of the acceptance. The “View Terms To Impose Charges Page” in FIG. 46 is then displayed. The carrier can then impose additional assessorial charges prior to billing, if assessorial charges are included in the contract. A charge imposed can be entered in text field 668.

Shipper's Market/Notification of Assessorial Charges

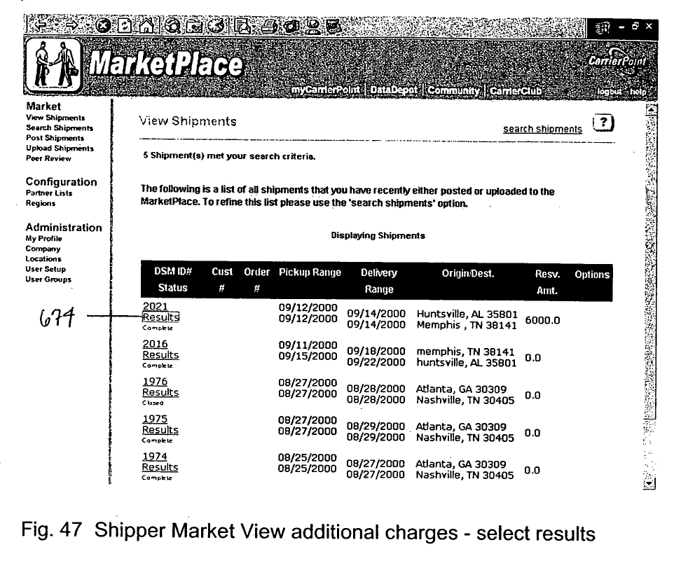

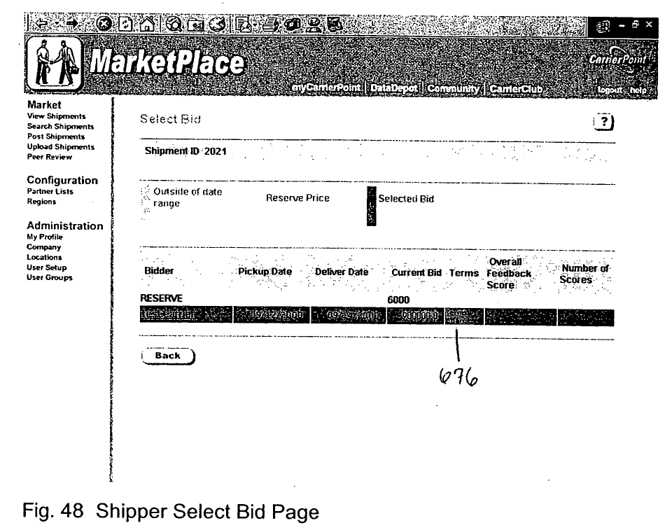

A shipper is notified about charges through the system. When viewing shipment results through the “Shipper Market View Additional Charges Page” illustrated in FIG. 47; the shipper selects the “results” hyperlink 674. The screen illustrated in FIG. 48 is displayed. The shipper can then select the “charges” hyperlink 676, and the contract between the shipper and the carrier is displayed including the accessorial “charges.”

System Architecture

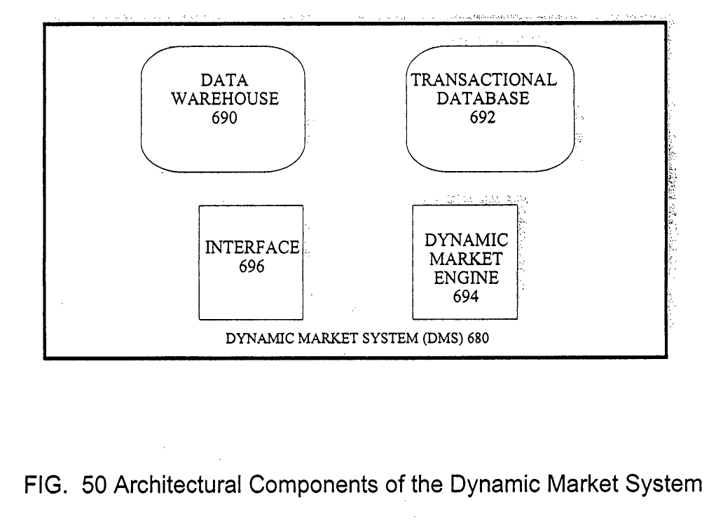

An exemplary embodiment of the system of the present invention for facilitating commerce between shippers and carriers is depicted in FIG. 49. The overall system architecture includes carriers 686, shippers 682, a network 684, and a DMS 680.

In accordance with the invention, DMS 680 accepts electronic shipment requests posted by shippers for available shipments from a shipper interface 682 via network 684. In like manner, DMS 680 accepts carrier fulfillment offers from a carrier interface 686 via network 684. At a minimum, the electronic shipment requests identify shipment specific criteria and carrier access criteria. Carrier access criteria defines at a minimum which carriers can bid on a posted shipment.

A network connection between the carrier and the DMS and the shipper and the DMS can be established using a standard network. Those of ordinary skill in the art will also recognize that the network connection can be established via high-speed digital networks, such as T1 and T3, infrared networks, satellite networks, and cellular networks. Any type of networking solution that provides for the interconnection of personal computers, terminals and/or telephones can be used as the network 684 element.

The carrier interface 686 and the shipper interface 682 provide the conduit for receiving and transmitting data to and from the DMS 680. These interfaces include screens for data entry and data reception. A conventional computer or computer workstation with the appropriate hardware and software can serve as the shipper and carrier interfaces.

The architectural components of the DMS is illustrated in detail in FIG. 50. The DMS comprises the basic components of a Dynamic Market Engine (DME) 694, as defined in the following paragraph, an interface 696, a transactional database 692, and a data warehouse 690. Those skilled in the art will realize that the functional components that make up the DMS 680 can be distributed over a plurality of computers or configured to run on only one server.

The DME is the heart of the DMS system. It provides the application logic for the entire real-time interaction between the shipper and carriers as well as interfaces with other services offered. The Transactional database 692 is the heart of the data information. It provides the structure for gathering and storing information specific to the shipping industry in an efficient and logical manner. The data warehouse 690 provides both shippers and carriers with the most up-to-date, customized and relevant information for them to plan and conduct their business. The interface 696 is the door to the DMS system and can be implemented in various ways relating to the access type employed by the carriers and shippers.

The DME 694 communicates with the interface 696 to receive the posted electronic shipment requests and carrier fulfillment offers and stores the requests and fulfillment offers in the transactional database 692. The DME 694 cooperates with the transactional database 692 to present electronic shipment requests to remote carriers meeting the carrier access criteria, and receives carrier fulfillment offers, at least satisfying the shipment specific criteria, responsive to presented electronic shipment request. System 680 then presents responsive carrier fulfillment to the remote shippers originating the electronic shipment request for further action by those shippers.

Manual Data Entry Architecture

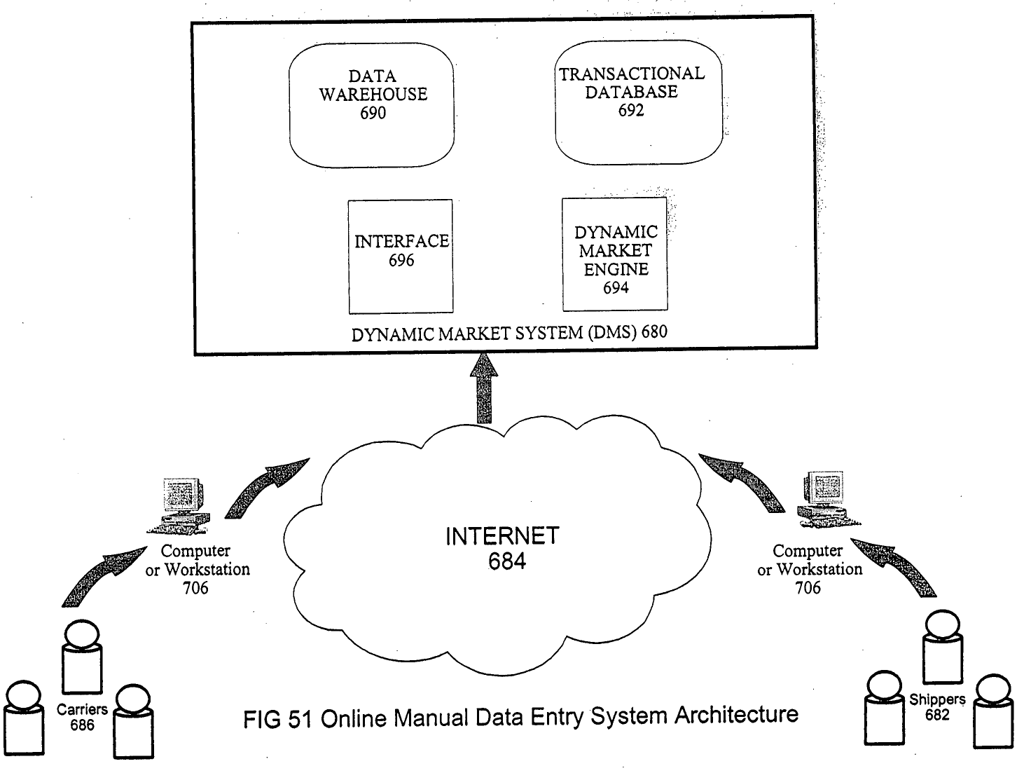

Referring now to FIG. 51, in this embodiment of the present invention, the carriers and shippers communicate with the DMS 680 online. The overall system architecture of this embodiment comprises a customer workstation or personal computer 706, a network 684, and a DMS 680. In this embodiment of the present invention the DMS comprises a marketplace transactional database or DataCentral™ 692, a marketplace data warehouse or DataDepot™ 690 a DME™ 694, and an interface or MyCarrierPoint™ 696.

In this embodiment, carriers and shippers, represented in FIG. 51 by 686 and 682, respectively, access the system manually via an Internet connection and a web browser. In this embodiment the interface 696 can be an interface portal. A new CarrierPoint™ customer in this embodiment accesses the DMS 680 by first accessing the CarrierPoint web page.

Referring to FIG. 51, electronic shipment requests are captured and stored by the DMS 680. A shipper is an individual 682 that logs onto the DMS 680 using shipper interface installed on the computer or workstation 706 establishing a communication link over the network 684. A shipper interface can be one of any off the shelf web browser such as Internet Explorer or Netscape Navigator. In this embodiment the interface 696 serves as a web server providing a web page on which the shipper can log in to the DMS 680. The shipper then manually enters shipment specific criteria and carrier access criteria into a web page. Shipment specific criteria are parameters such as the shipment contents, the weight of the shipment, the origin zip and the destination zip. Shipment specific criteria include that information necessary for a carrier to make a business decision on whether the carrier has the resources to carry the shipment.

Carrier access criteria delimits those carriers that may place a fulfillment offer on the shipment described in the corresponding shipment specific criteria. Carrier access criteria may take two forms. First, a shipper may define the carrier access criteria as the entire CarrierPoint community. Second, a shipper may define a partner list that lists those carriers that the shipper requests have visibility to the shipment specific criteria.

Referring again to FIG. 51, the shipment specific criteria and the carrier access criteria, are received by the DMS 680 through the interface 696. The DME 694 manages this data and writes this data into the transactional database 692. Thereafter, the transactional database stores this information in the data warehouse 690.

Shipment specific criteria are presented to a carrier in response to a carrier search request or by simply viewing open posted shipments. The carrier searches by entering criteria such as origination zip code, destination zip code, or delivery date. When a search query is initiated, the DME 694 initiates a search of the transactional database to obtain data on shipment requests corresponding to the carrier's search criteria. The DME 694 sends the query results obtained from the database 692 search to the interface portal 696 which in turn sends the display of the results of the search to the carrier. A carrier can search the plurality of open shipments and the associated shipment specific criteria by parameters such as origin zip, shipper, and type of goods. In response to the search request, carriers can place electronic fulfillment offers on shipments presented to the carrier.

In this embodiment, electronic fulfillment offers are received by the DMS 680 in the same manner in which the shipment requests are captured. A carrier is an individual 696 that logs onto the DMS 680 using an interface application on the computer or workstation 706 and establishing a communication link over the network 684. A carrier interface can be one of any off the shelf web browsers such as Internet Explorer or Netscape Navigator. In this embodiment the interface 696 serves as a web server providing a web page on which the shipper can log in to the DMS 680. The carrier then manually enters fulfillment offers responsive to shipment requests presented to the carrier.

The carrier fulfillment offers responsive to the presented electronic shipment requests are received by the interface 696 and managed by the DME 694. The DME 694 writes the responsive fulfillment offers to the transactional database 692. The DME 694 then presents the fulfillment offers to the remote shippers that originated the shipment requests. This presentation is achieved through the interface portal 696.

A carrier places a bid in like manner. A carrier enters bidding information that is captured by the interface portal 696. The interface portal serves as a conduit transferring the captured data to the DME 694. The DME 694 manages the data and stores the data in the transactional database 702. Once the bidding has begun on a posted shipment, the DMS 680 provides real-time access by the shippers to fulfillment offers placed on the DMS 680. A shipper is able to view the bidding information through sending a request to the interface portal 696. That transmits the shipper's request to the DME 694. The DME 694 then queries the data base for information relating to the fulfillment offers that have been placed on the open shipment request, then sends that information through the interface portal to be presented on the shipper interface 682. The next step in the method is the shipper selecting a fulfillment order.

Selection of a bid is also accomplished in like manner. The selection from a web page is captured by the interface portal 696 and transmitted to the DME 694. The DME manages the data received and indicates that a bid has been accepted. The data relating to the posted shipment and corresponding bid is flagged as a closed transaction in the transactional database 690. The carrier is notified in like manner. This notification can be in response to the carrier logging onto the system and manually accessing web pages.

Automated Data Entry

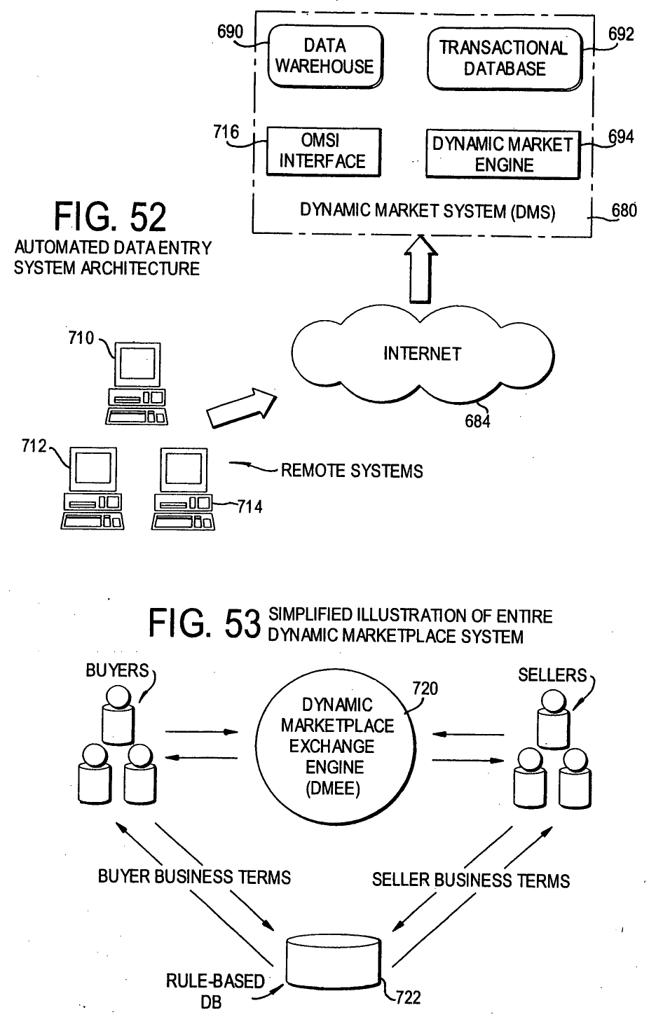

Another preferred embodiment of the present method and system is illustrated in FIG. 52. The components include one or more remote systems such as 710, 712, or 714, a network 684, and the DMS (DMS) 680. The DMS includes an interpretive interface or Open Market Services Interface (OMSI) 716, a Dynamic Market Engine (DME) 694, a transactional database 692, and a data warehouse 690.

One or more of the remote system such as 710, 712 or 714 access the DMS 680 over a network 684. The remote system can include systems such as a Transportation Management System (TMS), a Warehouse Management System (WMS) or an Enterprise Resource Planning System. These systems are software implemented business solutions internal to both the shippers' and the carriers' businesses. These systems employ a document format specification for the exchange of information with the DMS. A well-know document format specification is Extensible Markup Language (XML); however, one skilled in the art will recognize that other format specifications could be employed for the same purpose.

Remote systems can be systems such as Legacy, BAAN, BPCS, Logistics Pro, or PeopleSoft™. The systems can run on any type of platform such as UNIX, AS/40 or NT. The commonality that allows effective connection with the DMS 680 is the use of a format specification.

As illustrated in FIG. 52, the OMSI 716 of the DMS 680 is the interface for remote data entry. A plurality of remote systems post shipments that include carrier access criteria over the network 684.

In one embodiment, the automated system is implemented employing client/server architecture. The remote system behaves as a client to the DMS communicating with a server over any one of the connection types known in the art including internet, local area networks (LAN), wide area networks (WAN), or direct connection. One skilled in the art will recognize that this connection can be implemented in any number of ways. The DMS behaves as a server to the remote system client by communicating with the remote system in response to messages.

A remote client may consist of one or more database that stores data related to the carrier or shipper's business. This data can be accessed and used to create a document formatted to a defined specification that allows software applications to define, transmit, validate, and interpret data between the applications. The client can then send the formatted data either in a data bundle or as a message sequence to the server by employing any type of network protocol.

Implementation of the client in the present invention is dictated by the client hardware used by the customer. By way of example, a remote system client built on a UNIX platform may use Oracle tables to store its business data and stage the data in a useable schema. Additionally, the client side may use Java Database Connectivity (JDBC) to interact with the staged data to create an Extensible Markup Language (XML) formatted document, and Hyper text transfer protocol (HTTP) to transmit the data to the server.

The OMSI consists of the server side architecture implementation that allows the data using any document type definition (DTD) to be processed by the server.

Referring again to FIG. 52, the OMSI 716 serves as the interface between the remote systems and the DME.

In yet another embodiment of the present invention, market information can be received by the OMSI through a shipper-initiated spreadsheet. A file is formatted in a specific predefined format. For example, the spreadsheet may contain a file identification section that provides information such as a login identification, a password, and currency type. In addition, the file may contain a shipment information section that provides the specific parameters of the market being initiated. These parameters may include market information describing a partner list, market type, reserve amount, origination zip code, and destination zip code.

This information is received by the OMSI and provided to the DME for processing. The DME creates and manages the market initiated by the shipper by cooperating with the transactional database. The market is presented to carriers in accordance with the shipment information parameters received by the DMS via the spreadsheet.

Reporting Services

Another embodiment of the present invention is an extensive analytical reporting system. This is accomplished with the architecture referred in FIG. 51. Once transactions are closed the transactional database 692 provides the market data to the data warehouse 690. The data warehouse 690 is responsible for the implementation of the reporting service. The data warehouse 690 then answers questions relating to historical business practices of CarrierPoint carriers and shippers. This information is compiled, and the carrier or shipper can access this information through the computer or workstation 706 over the network 684. The information presented to the carriers or shippers includes Management Reporting information to allow carriers and shippers to perform such tasks as forecasting or resource management based on historical behavior. The information obtained from the reporting services allows customers access to audit and analyze their businesses.

Electronic Matching

Another embodiment of the present method and system is a system and method that employs an automated matching system in order to facilitate commerce between carriers and shippers. This system can be described by referring to FIG. 53.

The DMS of this embodiment of the present invention includes a Dynamic Marketplace Exchange Engine (DMEE) and a Rule-Based Database 722.

A rule-based database 720 is built using shippers' business rules and carriers' business rules. The rules can be created by obtaining from the shipper or carrier static data including, but not limited to, lanes used by a shipper, carrier service area, types of vehicles available by carriers for service, the types of vehicles needed, or any other parameter that defines the type of service required by a shipper and the type of service available from a carrier. The data can be captured and stored electronically in any manner know in the art including, but not limited to a web page where the shipper or carrier enters the necessary data. The rules can be created and stored according to shipper and carrier. The database can then implement a series of indexes for each shipper and carrier related to each rule.

In addition to the static data used to create the rule-based database 720, the Dynamic Marketplace Exchange Engine (DMEE) 722 can capture from a shipper a shipment request that includes data such as origination zip code, destination zip code, number of packages, type of goods, pick-up date, and delivery date. Simultaneously, the DMS can capture from carriers dynamic data related to the carrier's availability including the availability of carrier transport vehicles, delivery dates, pick-up dates, and specific data related to a carrier's available services.

The DMEE 720 accepts this dynamic data from the shippers and the carriers and can either store the data in a database or use temporary storage. The DMEE then uses the data obtained from the shipping request to search the rule-based database to determine eligible carriers. The results from this search can then be processed using any of a number of comparison algorithms to determine if the eligible carriers determined by the rule-based search have available capacity to fulfill a shipment request.

The eligible carriers can then be communicated to the shipper whereupon the shipper can choose a carrier's service.

It will be apparent to those skilled in the electronic commerce art that various modifications and variations can be made to the present invention without departing from the spirit and scope of the invention. For instance, the system and method of the present invention can be employed in industries other than the trucking industry. Moreover, those of ordinary skill in the art will recognize that a computer programming language other than HTML and XML (the principle languages used to construct the system of the present invention) could be used to construct the system and method of the present invention. Thus, it is intended that the present invention covers the modifications and variations of this invention provided they come within the scope of the appended claims and their equivalents.

1. A method of facilitating commerce between shippers and carriers, said method comprising the steps of.
a) capturing electronic shipment requests for available shipments, said electronic shipment requests originating from remote shippers and including shipment specific criteria and carrier access criteria;
b) storing said electronic shipment requests in a database of a DMS;
c) presenting said electronic shipment requests to remote carriers meeting the carrier access criteria;
d) receiving carrier fulfillment offers responsive to said presented electronic shipment requests; and
e) presenting said responsive carrier fulfillment offers to the remote shippers originating said electronic shipment requests.

2. The method of claim 1 wherein said carrier fulfillment offers at least satisfy the shipment specific criteria.

3. The method of claim 1 further comprising the step of:
f) selecting one or more carrier fulfillment offers for the available shipments.

4. The method of claim 1 wherein the step of presenting said electronic shipment requests comprises the step selected from the group consisting of delivering said electronic shipment requests to the remote carriers in response to a remote carrier search of said DMS or electronically notifying the remote carriers meeting the carrier access criteria.

5. The method of claim 2 further comprising the step of notifying the remote carriers when their fulfillment offers are accepted by the remote shippers.

6. The method of claim 3 further comprising the step of facilitating an electronic payment from the remote shipper to the selected remote carrier.

7. The method of claim 4 further comprising the step of storing said electronic shipment requests, said carrier fulfillment offers, and information relating to said electronic payment in said database of said DMS.

8. The method of claim 5 further comprising the steps of analyzing the information stored in said database and presenting the information stored in said database to the shippers and carriers.

9. A method of claim 1 wherein the step of capturing said electronic shipment requests comprises the step of receiving manually entered electronic shipment requests through a user interface.

10. A method of claim 1 wherein the step of capturing electronic shipment requests comprises the step of receiving electronic shipment request from a remote automated system.

11. A method of claim 8 wherein the step of receiving shipment requests further comprises the step of defining and interpreting communication protocol employed by said DMS.

12-15. (canceled)

16. A system constructed and arranged to facilitate commerce between shippers and carriers, said system comprising:
a) an interface communicating with remote shippers and carriers in a network environment to accept electronic shipment requests for available shipments and to accept carrier fulfillment offers, the electronic shipment requests identifying shipment specific criteria and carrier access criteria; and
b) a dynamic market system including a dynamic market engine, said dynamic market engine communicating with said interface to receive said electronic shipment requests and said carrier fulfillment offers and store said shipment requests and fulfillment offers in the database, said dynamic market engine cooperating with the database to present said electronic shipment requests to remote carriers meeting the carrier access criteria, receive carrier fulfillment offers responsive to said presented electronic shipment requests, and present said responsive carrier fulfillment offers to the remote shippers originating said electronic shipment requests.

17. The system of claim 14 wherein the carrier fulfillment offers at least satisfy the shipment specific criteria.

18. The system of claim 14 wherein said dynamic market engine comprises an instruction selected from the group consisting of a first instruction configured to deliver said electronic shipment requests to the remote carriers in response to a remote carrier search of said system or a second instruction configured to automatically notify the remote carriers meeting the carrier access criteria.

19. A system constructed and arranged to facilitate commerce between shippers and carriers, said system comprising:
a) an interface communicating with remote systems in a network environment to accept electronic shipment requests for available shipments and to accept carrier fulfillment offers, the electronic shipment requests identifying shipment specific criteria and carrier access criteria; and
b) a dynamic market system including a dynamic market engine, a database and an open market services interface constructed and arranged to interpret the electronic shipment requests and store the interpreted electronic shipment requests in the database, the dynamic market engine cooperating with the open market services interface and the database to present said electronic shipment requests to remote carriers meeting the carrier access criteria, receive carrier fulfillment offers responsive to said presented electronic shipment requests and present said responsive carrier fulfillment offers to the remote shippers originating said electronic shipment requests.

20. (canceled)
